(19) United States
(12) Patent Application Publication
(10) Pub. No.: US 2013/0206868 A1
(43) Pub. Date: Aug. 15, 2013

(54) Hose End Dispenser Having Vent

(71) Applicant: Martin S. Laffey, Saint Joseph, MO (US)

(72) Inventor: Martin S. Laffey, Saint Joseph, MO (US)

(21) Appl. No.: 13/567,968

(22) Filed: Aug. 6, 2012

Related U.S. Application Data
(60) Provisional application No. 61/515,664, filed on Aug. 5, 2011.

(51) Int. Cl. B05B 7/04

(52) U.S. Cl. CPC B05B 7/0408
USPC 239/407

(57) ABSTRACT

A hose end dispenser for dispensing a carrier fluid and an aspiration fluid. The dispenser includes a body including a carrier fluid inlet and an aspiration fluid inlet. The dispenser includes a nozzle configured for dispensing the carrier fluid and the aspiration fluid. A valve includes a valve member and a valve housing. The valve member is rotatable in the valve housing about the axis of rotation for moving the valve member between an open position in which the valve member permits flow of carrier fluid through the valve member and a closed position in which the valve member blocks flow of carrier fluid through the valve member.

### FIELD OF THE INVENTION

The present disclosure generally relates to a dispenser, and more particularly to a hose end dispenser having a vent.

### BACKGROUND OF THE INVENTION

Hose end dispensers (e.g., hose end sprayers) may be used in various applications for dispensing fluids. For example, a hose end sprayer may be used for applying liquid pesticides, herbicides, fungicides, or fertilizer on garden or lawn foliage. As another example, a hose end sprayer may be used for applying liquid detergent on exterior window surfaces for cleaning the windows. These applications are provided by way of example and not limitation. Hose end dispensers may be used for dispensing various other substances and in various other applications.

### SUMMARY

In one aspect, the present invention is directed to a hose end dispenser for dispensing a carrier fluid and an aspiration fluid. The dispenser is adapted for operation by a single hand of a user. The hand includes a plurality of fingers including a thumb. The dispenser includes a body including a carrier fluid inlet and an aspiration fluid inlet. The dispenser also includes a nozzle configured for dispensing the carrier fluid and the aspiration fluid. The nozzle is positioned downstream from carrier fluid inlet and the aspiration fluid inlet. A valve downstream from the carrier fluid inlet and upstream from the nozzle includes a valve member and a valve housing. The valve member is rotatable in the valve housing about and axis of rotation for moving the valve member between an open position in which the valve member permits flow of carrier fluid through the valve member and a closed position in which the valve member blocks flow of carrier fluid through the valve member. The dispenser includes a rocker lever connected to the valve member. The rocker lever is configured for rocking actuation by the thumb of the hand for moving the valve member between the open and closed positions. The body includes a grip having a top, a bottom, a rear end, a front end, and a length extending between the front and rear ends. The grip is positioned in front of the carrier fluid inlet and behind the nozzle. The grip includes a gripping surface extending along the length of the grip. The gripping surface is sized and shaped for receiving fingers of the hand wrapped on the gripping surface including fingers of the hand positioned one in front of the other between the rear and front ends of the grip. The rocker lever is positioned for actuation by the thumb when the fingers are wrapped on the gripping surface.

In another aspect, the present invention is directed to a hose end dispenser for dispensing a carrier fluid and an aspiration fluid. The dispenser includes a body including a carrier fluid inlet and an aspiration fluid inlet. The dispenser also includes a nozzle configured for dispensing the carrier fluid and the aspiration fluid. The nozzle is positioned downstream from carrier fluid inlet and the aspiration fluid inlet. A valve is positioned downstream from the carrier fluid inlet and aspiration fluid inlet and upstream from the nozzle. The valve includes a valve member and a valve housing. The valve member is rotatable in the valve housing about the axis of rotation for moving the valve member between an open position in which the valve member permits flow of carrier fluid through the valve member and a closed position in which the valve member blocks flow of carrier fluid through the valve member. The valve includes a stop including a protrusion and a track. The track has first and second ends and a length extending between the ends. The track receives the protrusion and permits the protrusion to move along a length of the track when the valve member is moved between the open and closed positions. The protrusion is positioned at one of the first and second ends of the track when the valve member is in one of the open and closed positions for preventing rotation of the valve member beyond said one of the open and closed position.

In yet another aspect, the present invention is directed to a hose end dispenser for dispensing a carrier fluid and an aspiration fluid. The dispenser includes a body including a carrier fluid inlet and an aspiration fluid inlet. The dispenser also includes a nozzle configured for dispensing the carrier fluid and the aspiration fluid, the nozzle being positioned downstream from carrier fluid inlet and the aspiration fluid inlet. A valve is positioned downstream from the carrier fluid inlet and aspiration fluid inlet and upstream from the nozzle. The valve includes a valve member and a valve housing. The valve member is rotatable in the valve housing about the axis of rotation for moving the valve member between an open position in which the valve member permits flow of carrier fluid through the valve member and a closed position in which the valve member blocks flow of carrier fluid through the valve member. The dispenser also includes a vent valve. The vent valve includes a cover and a vent passage. The cover has an open position in which vent fluid is permitted to flow through the vent passage, and the cover has a closed position in which vent fluid is blocked from flowing through the vent passage. The valve member includes structure which engages the vent valve cover and moves the vent valve cover to the open position of the vent valve cover in response to rotation of the valve member toward the open position of the valve member.

### BRIEF DESCRIPTION OF THE DRAWINGS

FIG. 1 is a right front perspective of a hose end dispenser of a first embodiment of the present invention;

FIG. 2 is a right elevation of the dispenser of FIG. 1, the left side elevation being a mirror image;

FIG. 3 is a front elevation of the dispenser of FIG. 1;

FIG. 4 is a rear elevation of the dispenser of FIG. 1;

FIG. 5 is a top view of the dispenser of FIG. 1;

FIG. 6 is a bottom view of the dispenser of FIG. 1;

FIG. 7 is an exploded left front perspective of the dispenser of FIG. 1;

FIG. 8 is a rear elevation of a nozzle and a valve member of a valve of the dispenser of FIG. 1;

FIG. 9 is a lower left side perspective of the valve member and nozzle of FIG. 8;

FIG. 10A is a side elevation of the dispenser of FIG. 1 showing the valve in an “off” position, a lower body member of the dispenser being lowered from an upper body member for exposing stops on the valve for limiting rotational movement of the valve;

FIG. 10A′ is an enlarged view of a portion of the side elevation shown in FIG. 10A;

FIG. 10B is a view similar to FIG. 10A but showing the valve in an “on” position;

FIG. 10B′ is an enlarged view of a portion of the side elevation shown in FIG. 10B;

FIG. 11A is a section of the dispenser of FIG. 1 taken in the plane including line 11-11 in FIG. 3, the valve being shown in the “off” position;

FIG. 11B is a view similar to FIG. 11A but showing the valve in the “on” position;

FIG. 12A is a section of the dispenser of FIG. 1 taken in the plane including line 12-12 in FIG. 3, the valve being shown in the “off” position;

FIG. 12A′ is an enlarged view of a portion of the section of FIG. 12A;

FIG. 12B is a view similar to FIG. 12A but showing the valve in the “on” position;

FIG. 12B′ is an enlarged view of a portion of the section of FIG. 12B;

FIG. 13 is a right front perspective of a hose end dispenser of a second embodiment of the present invention;

FIG. 14 is a right elevation of the dispenser of FIG. 14, the left side elevation being a mirror image;

FIG. 15 is a front elevation of the dispenser of FIG. 14;

FIG. 16 is as rear elevation of the dispenser of FIG. 14;

FIG. 17 is a top view of the dispenser of FIG. 14;

FIG. 18 is a bottom view of the dispenser of FIG. 14;

FIG. 19 is a right front perspective of a hose end dispenser of a third embodiment of the present invention;

FIG. 20 is a right elevation of the dispenser of FIG. 19, the left side elevation being a mirror image;

FIG. 21 is a front elevation of the dispenser of FIG. 19;

FIG. 22 is a rear elevation of the dispenser of FIG. 19;

FIG. 23 is a top view of the dispenser of FIG. 19;

FIG. 24 is a bottom view of the dispenser of FIG. 19;

FIG. 25 is a right front perspective of a hose end dispenser of a fourth embodiment of the present invention;

FIG. 26 is a right elevation of the dispenser of FIG. 25, the left side elevation being a mirror image;

FIG. 27 is a front elevation of the dispenser of FIG. 25;

FIG. 28 is a rear elevation of the dispenser of FIG. 25;

FIG. 29 is a top view of the dispenser of FIG. 25;

FIG. 30 is a bottom view of the dispenser of FIG. 25;

FIG. 31 is an exploded left front perspective of the dispenser of FIG. 25;

FIG. 32 is a rear elevation of a nozzle and a valve member of a valve of the dispenser of FIG. 25;

FIG. 33 is a lower left side perspective of the valve member and nozzle of FIG. 32;

FIG. 34A is a section view of the dispenser of FIG. 25 taken in the plane including line 34-34 in FIG. 27, the valve being shown in an “off” position;

FIG. 34B is a similar view to FIG. 34A but showing the valve in an “on” position;

FIG. 35A is a section view of the dispenser of FIG. 25 taken in the plane including line 35-35 in FIG. 27, the valve being shown in an “off” position;

FIG. 35A′ is an enlarged view of a portion of the side elevation shown in FIG. 35A;

FIG. 35B is a similar view to FIG. 35A but showing the valve in an “on” position;

FIG. 35B′ is an enlarged view of a portion of the side elevation shown in FIG. 35B;

FIG. 36 is a right front perspective of a hose end dispenser of a fifth embodiment of the present invention;

FIG. 37 is a right elevation of the dispenser of FIG. 36, the left elevation being a mirror image;

FIG. 38 is a front elevation of the dispenser of FIG. 26;

FIG. 39 is a rear elevation of the dispenser of FIG. 26;

FIG. 40 is a top view of the dispenser of FIG. 26;

FIG. 41 is a bottom view of the dispenser of FIG. 26;

FIG. 42 is a right front perspective of a hose end dispenser of a sixth embodiment of the present invention;

FIG. 43 is a right elevation of the hose dispenser of FIG. 42, the left side elevation being a mirror image;

FIG. 44 is a front elevation of the dispenser of FIG. 42;

FIG. 45 is a rear elevation of the dispenser of FIG. 42;

FIG. 46 is a top view of the dispenser of FIG. 42;

FIG. 47 is a bottom view of the dispenser of FIG. 42;

FIG. 48 is a right front perspective of a hose end dispenser of a seventh embodiment of the present invention;

FIG. 49 is a front elevation of the dispenser of FIG. 48;

FIG. 50 is an exploded left front perspective of the dispenser of FIG. 48;

FIG. 51 is a perspective of a gasket of the dispenser of FIG. 48;

FIG. 52 is a top view of the gasket of FIG. 51;

FIG. 53 is an enlarged top perspective of a portion of a valve housing of the dispenser of FIG. 48;

FIG. 54 is an enlarged bottom perspective of a portion of the valve housing of the dispenser of FIG. 48;

FIG. 55 is a lower left side perspective of a valve member and nozzle of the dispenser of FIG. 48;

FIG. 56 is a side elevation of the valve member and nozzle of FIG. 55;

FIG. 57A is a section view of the dispenser of FIG. 48 taken in the plane including line 57-57 in FIG. 49, the valve being shown in an “off” position;

FIG. 57A′ is an enlarged view of a portion of the side elevation shown in FIG. 57A;

FIG. 57B is a similar view to FIG. 57A but showing the valve in an “on” position;

FIG. 57B′ is an enlarged view of a portion of the side elevation shown in FIG. 57B.

### DETAILED DESCRIPTION

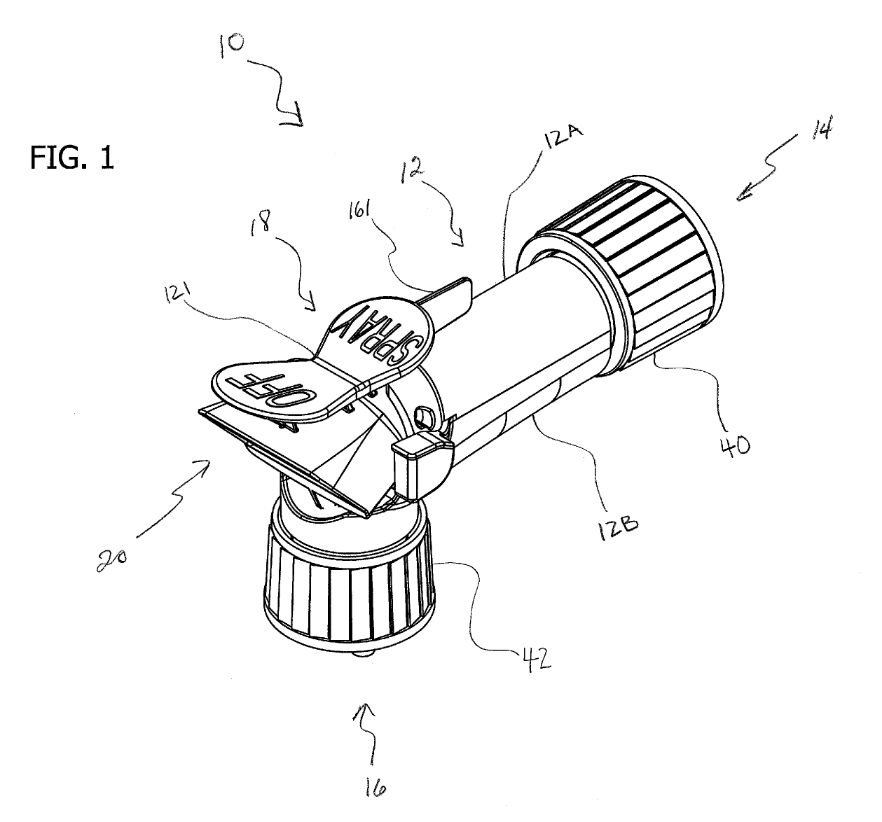

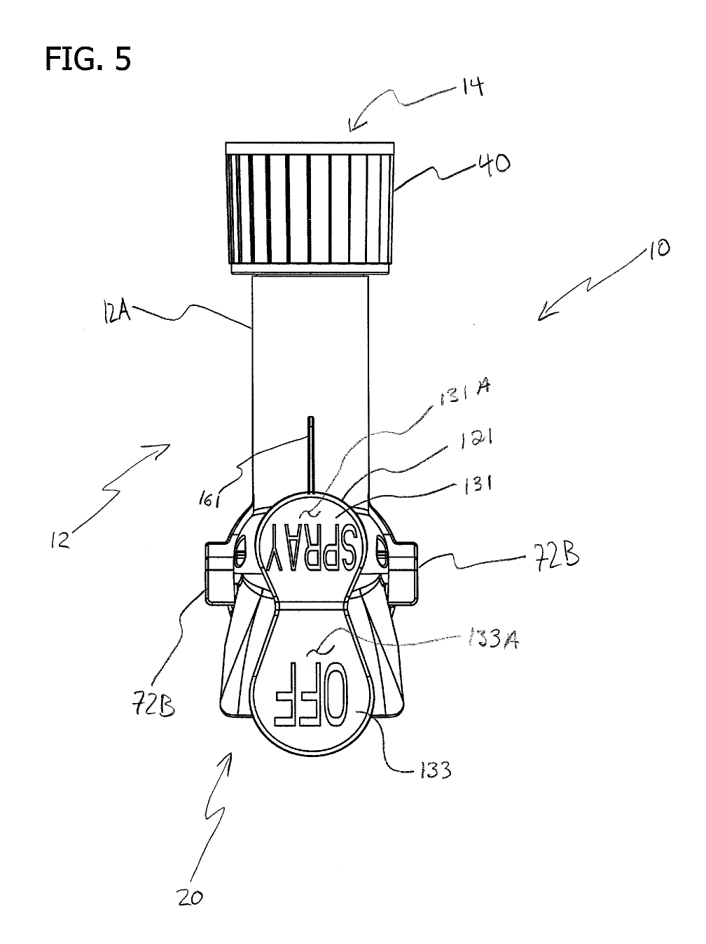

Referring to FIGS. 1-12, a hose end dispenser constructed according to principles of the present invention is designated generally by the reference number 10. In general, the hose end dispenser 10 may be used for mixing an aspiration fluid with a carrier fluid and dispensing the mixture. For example, the hose end dispenser 10 may mix concentrated liquid pesticides, herbicides, fungicides, or fertilizer with a carrier fluid such as water for creating a mixture to be dispensed on a desired surface such as lawn or garden foliage. In some embodiments, such as the embodiments illustrated herein, the hose end dispenser is a sprayer configured for dispensing the mixture by spraying. Dispensers other than sprayers (e.g., foam dispensers) may be used without departing from the scope of the present invention.

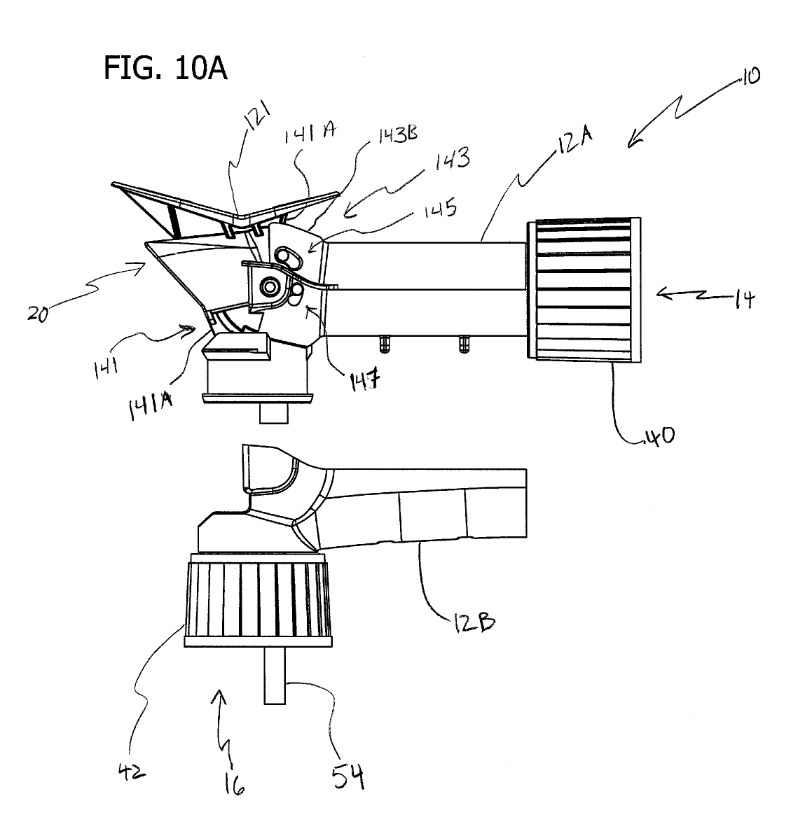

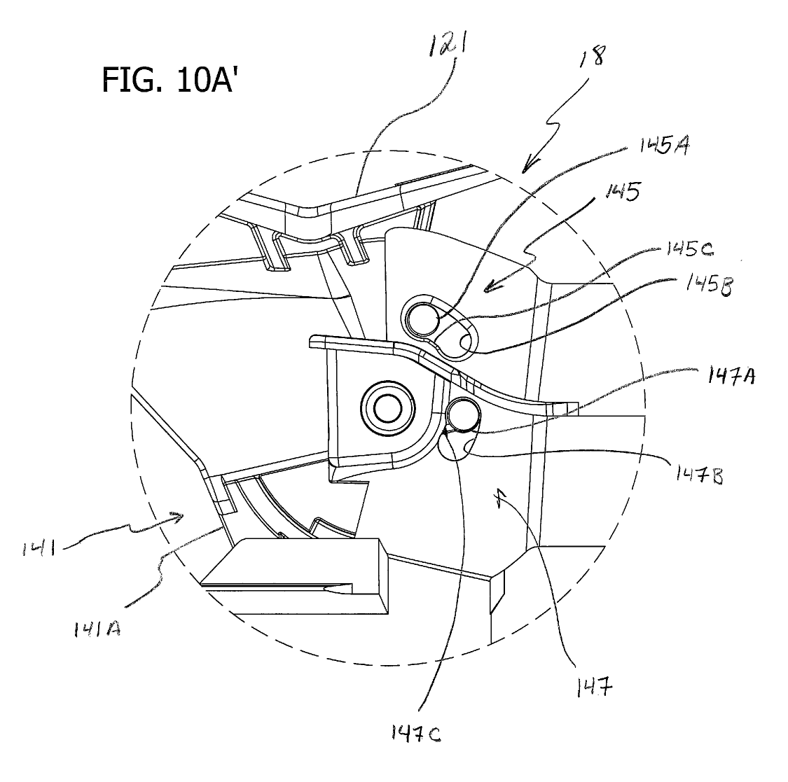

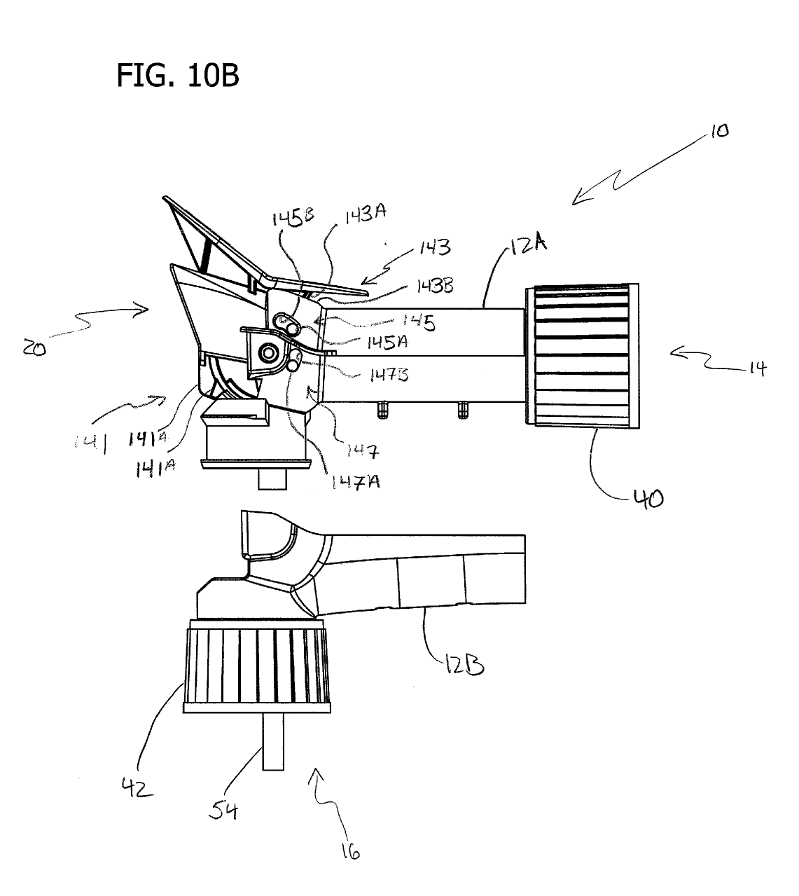

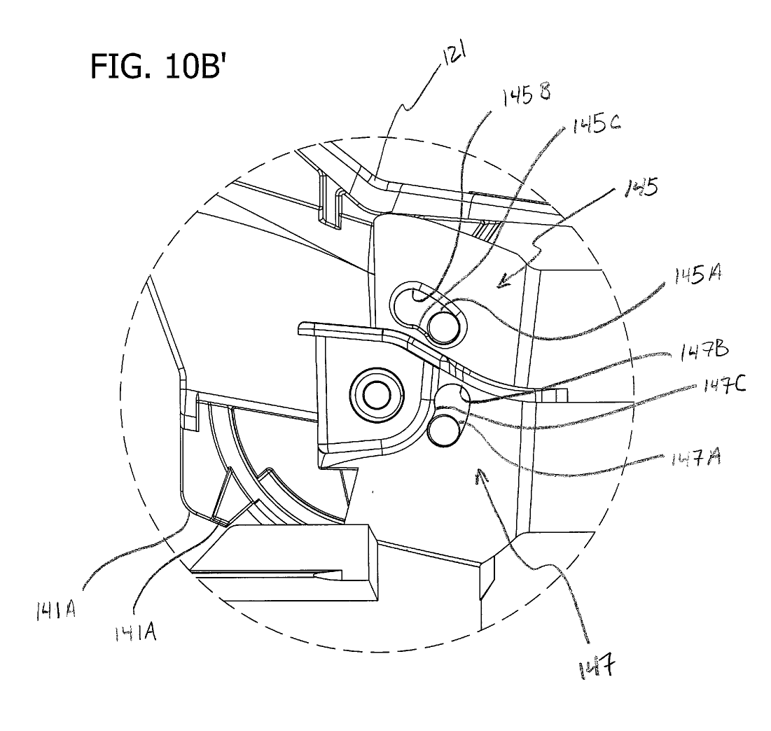

As shown in FIG. 1, the dispenser 10 includes a body 12, a carrier fluid inlet 14, an aspiration fluid inlet 16, a valve 18, and a nozzle 20, all of which are designated generally. For example, a garden hose (not shown) may be connected to the carrier fluid inlet 14 for supplying water as the carrier fluid. A reservoir (not shown) such as a container or bottle which contains fluid to be aspirated may be connected to the aspiration fluid inlet 16. As will be explained in further detail below, the valve 18 may be selectively actuated to control flow of fluid through the hose end dispenser 10. The valve 18 has an “off” position, shown in FIGS. 10A, 11A, and 12A, in which the valve is closed and fluid flow through the valve is blocked, and the valve has an “on” or “spray” position, shown in FIGS. 10B, 11B, and 12B, in which the valve is open and fluid flow is permitted through the valve. When the valve 18 is open, flow of the carrier fluid through the hose end dispenser 10 creates suction which causes the aspiration fluid to be siphoned or aspirated from the reservoir and mixed with the carrier fluid. The mixture of the carrier fluid and the aspiration fluid is sprayed from the nozzle 20. In the illustrated embodiment, the valve 18 and the nozzle 20 are integrated into a single unit.

Components of the hose end dispenser 10 described herein may be formed of various suitable materials. For example, the components may be formed of various plastics (e.g., by injection molding) or may be formed of various metals. Other materials may be used without departing from the scope of the present invention.

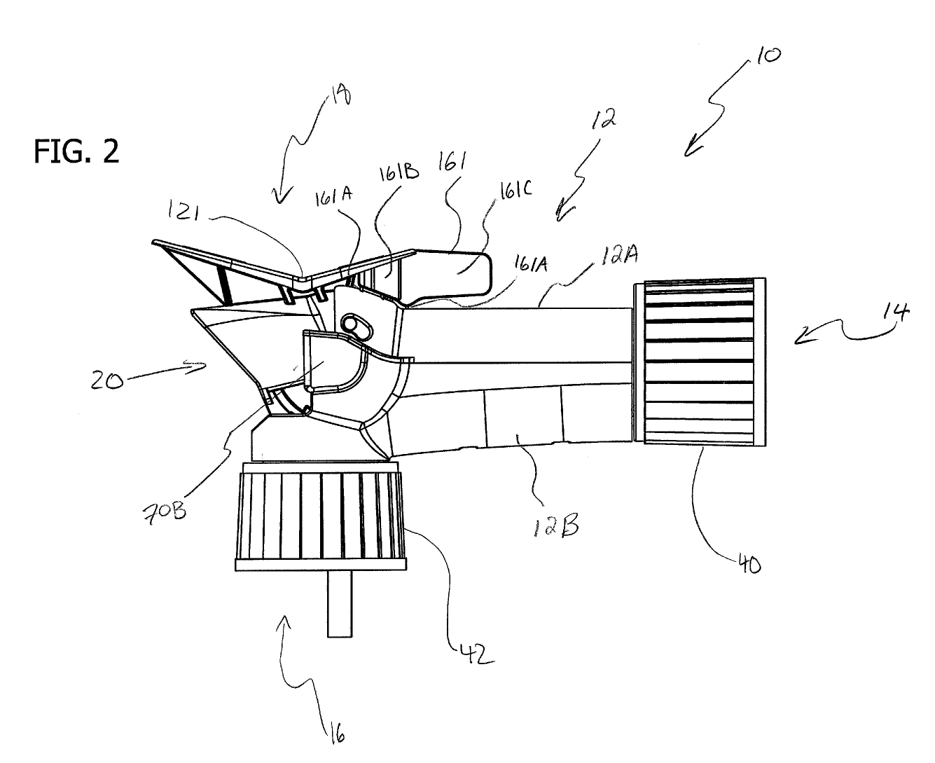

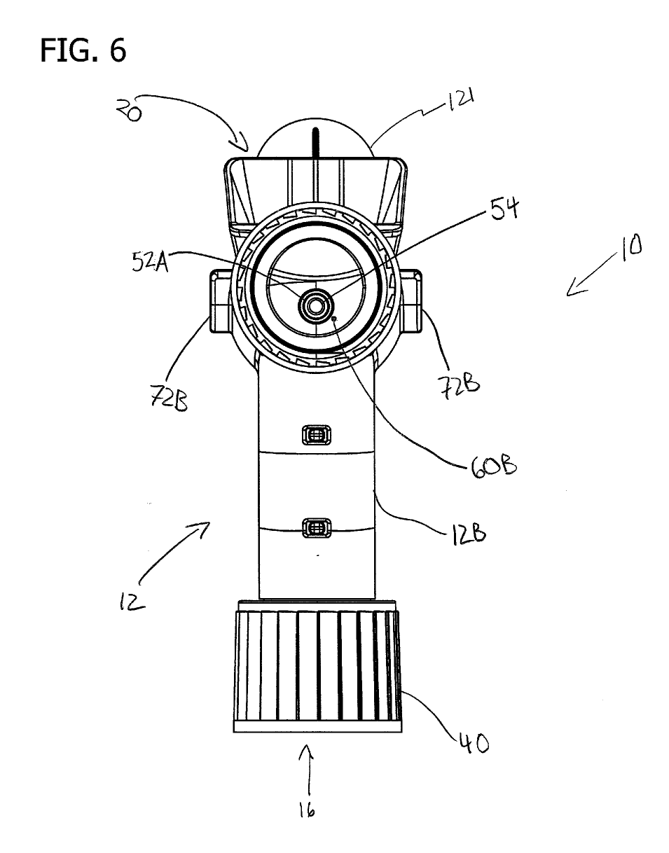

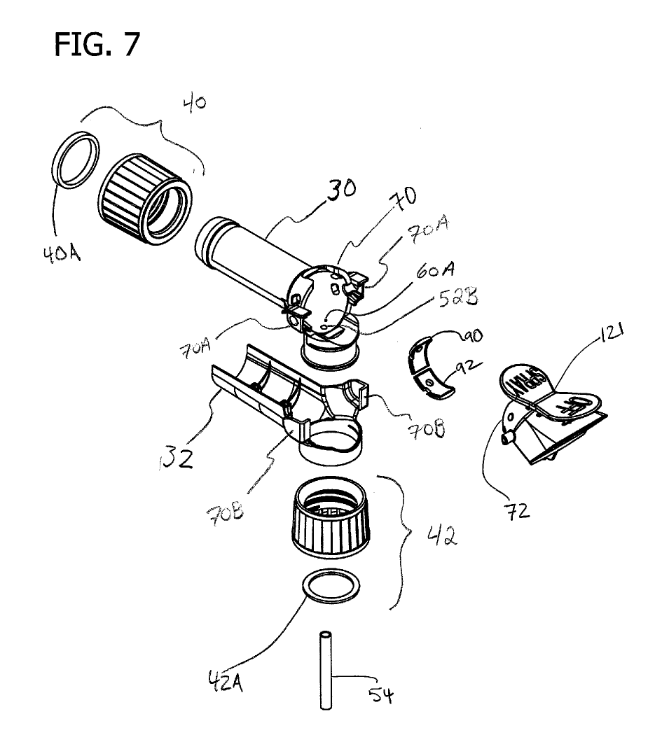

Referring to FIG. 2, the dispenser body 12 includes a main portion 12A. The main portion 12A has a generally elongate shape having a generally cylindrical outer surface which is sized and configured for gripping by a hand of a user. For example, a user may rest their thumb on the valve 18 and wrap other fingers of the same hand on the main portion 12A of the body 12. A gripping surface 12B is formed on a lower surface of the body 12. In the illustrated embodiment, the gripping surface 12B is segmented but is otherwise a generally uniform, rounded surface. In other embodiments, the gripping surface may be formed with enhanced contours for conforming to fingers gripping the main portion. As shown in FIG. 7, the body 12 is formed by upper and lower body members 30, 32. When assembled, the lower body member 32 is received on a lower side of the upper body member 30, and the lower body member is secured to the upper body member with suitable fasteners (FIG. 6) such as pins extending through openings in the lower body member. The lower body member 32 defines the gripping surface 12B.

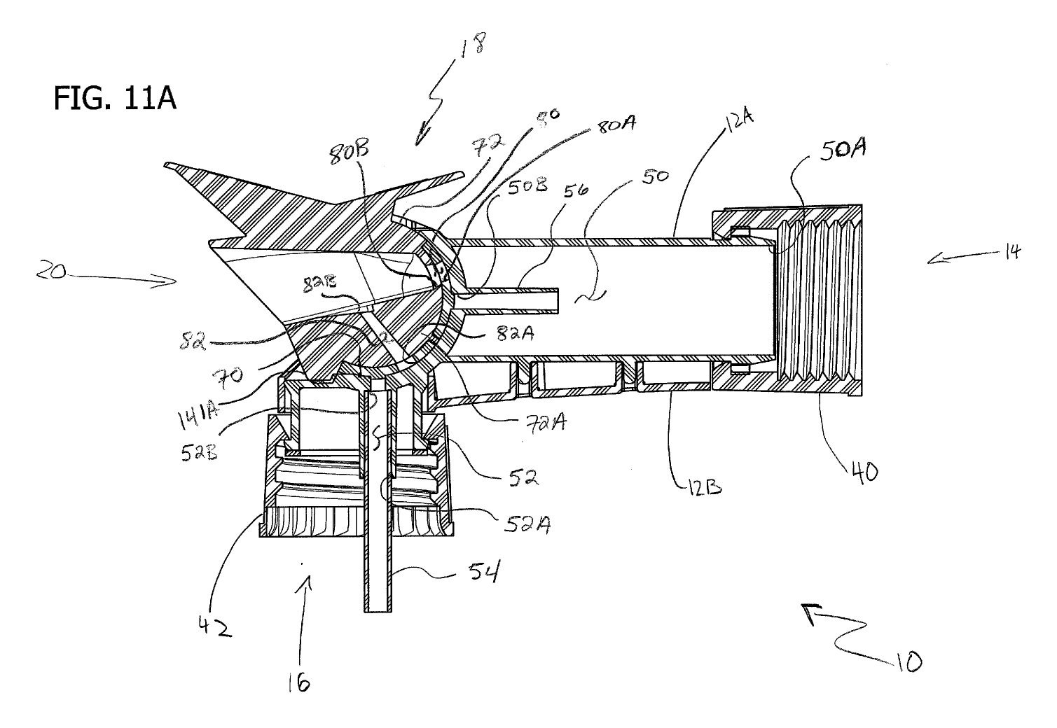

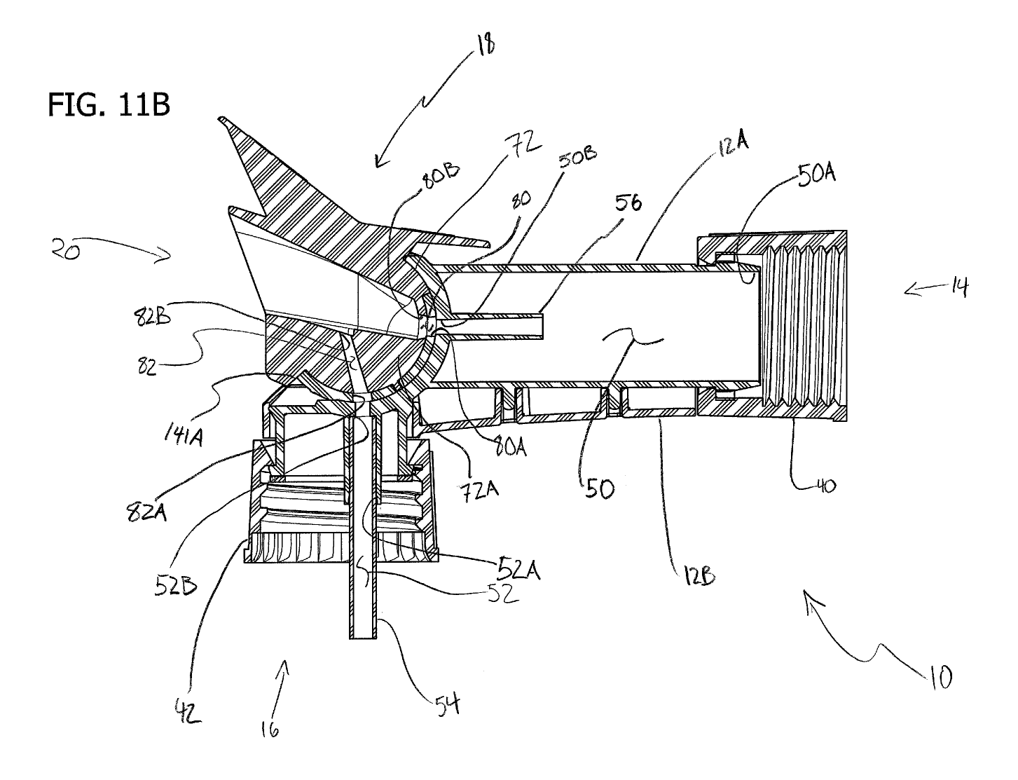

A first connector 40 is provided on the main portion 12A of the body 12 for connecting the body in fluid communication with a source of carrier fluid such as a garden hose. A second connector 42 is provided on the second portion of the body for connecting the body in fluid communication with a source of aspiration fluid. The connectors 40 and 42 have similar configurations. As shown in FIGS. 7 and 11A, the connectors 40 and 42 each include a sleeve having internal threads corresponding to external threads on a respective garden hose connector or aspiration fluid reservoir connector. The sleeve 40 has a textured (e.g., stepped or ribbed) outer surface for facilitating gripping of the sleeve for rotating it to form a threaded connection with the hose connector. Each connector 40 and 42 also includes an internal gasket or O-ring 40A and 42A against which the hose connector seats for forming a fluid tight connection.

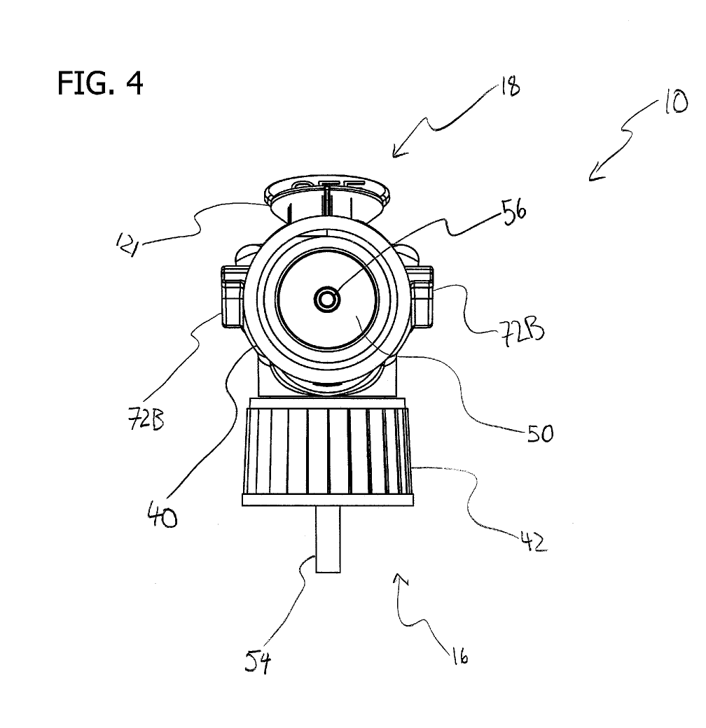

Referring to FIG. 11A, the body 12 defines a carrier fluid passage 50 and an aspiration fluid passage 52. As shown in FIGS. 4 and 11A, a carrier fluid passage inlet opening 50A is positioned at an upstream end of the carrier fluid passage 50 adjacent to the first connector 40. As shown in FIGS. 6 and 11A, an aspiration fluid passage inlet opening 52A is provided at an upstream end of the aspiration fluid passage 52 adjacent to the second connector 42. A siphon tube 54 extends downward from the aspiration fluid passage inlet 52A. As shown in FIG. 11A, a carrier fluid passage outlet opening 50B and an aspiration fluid passage outlet opening 52B are positioned at respective downstream ends of the carrier fluid passage 50 and the aspiration fluid passage 52. Referring to FIG. 11A, a tube 56 is provided inside the carrier fluid passage 50 which restricts flow of the carrier fluid from the carrier fluid inlet opening 50A to the carrier fluid outlet opening 52B.

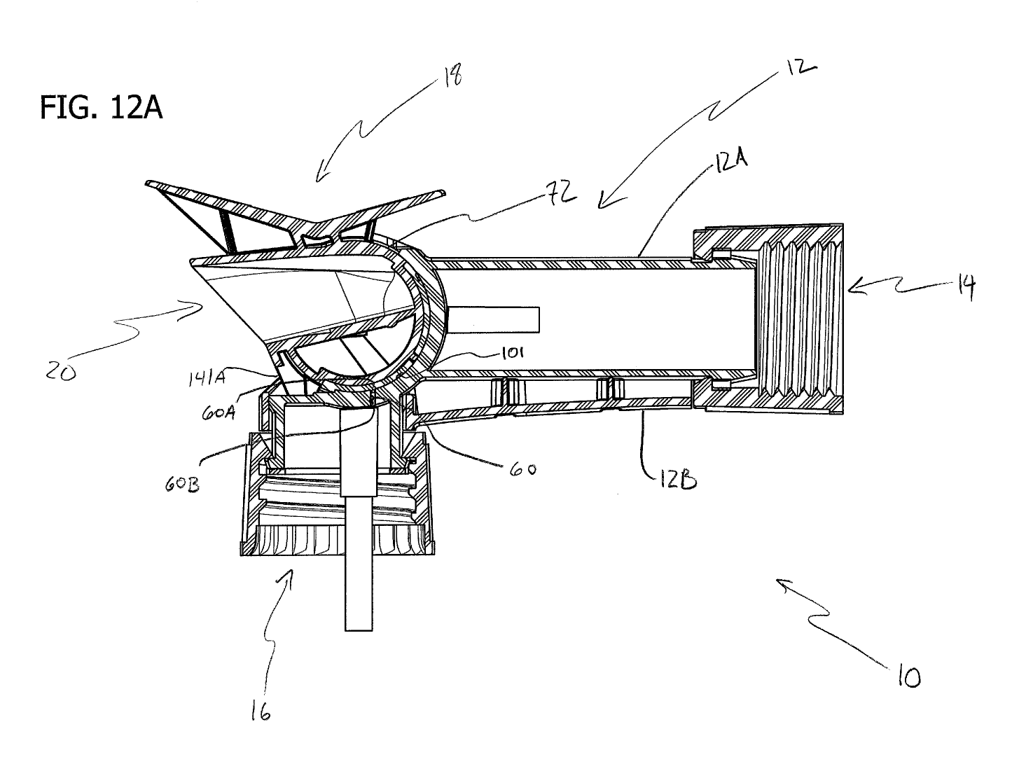

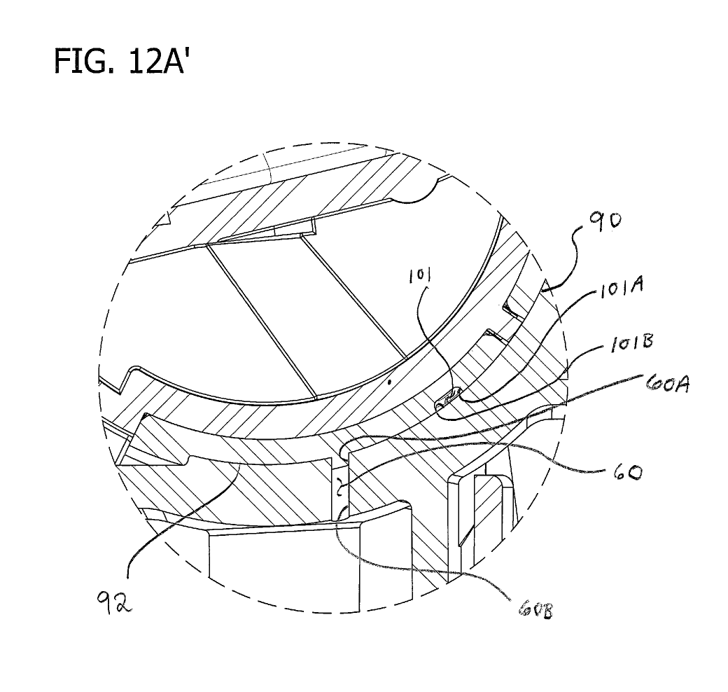

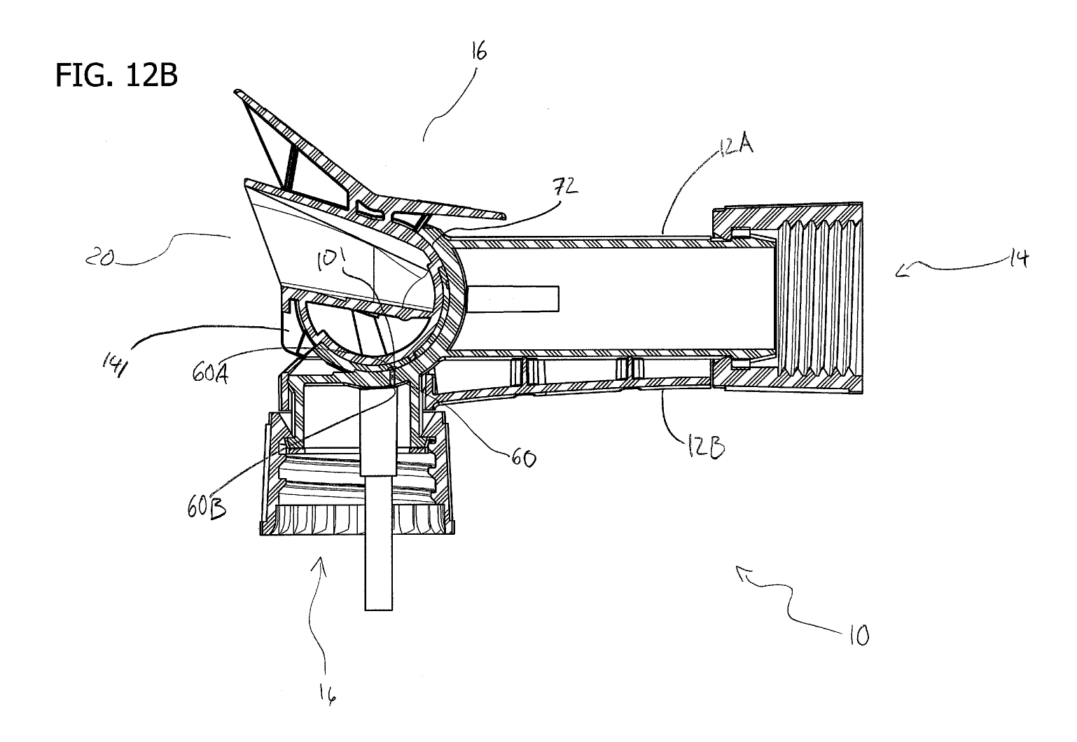

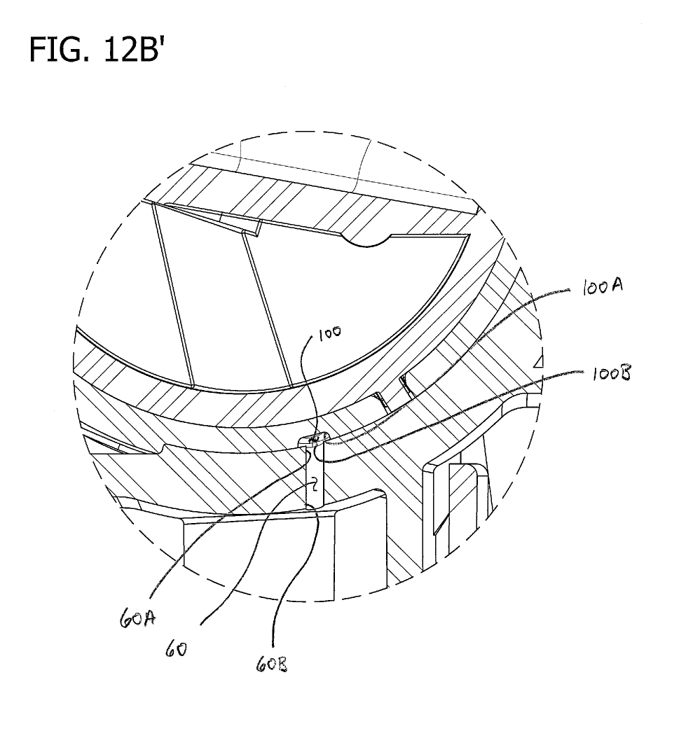

Referring to FIG. 12A, the body 12 also defines a vent passage 60. The vent passage 60 provides fluid communication between the open atmosphere and an interior of an aspiration fluid reservoir connected to the dispenser 10. As shown in FIGS. 7 and 12A, a vent passage inlet opening 60A is provided at an upstream end of the vent passage 60. As shown in FIGS. 6 and 12A, a vent passage outlet opening 60B is provided at a downstream end of the vent passage 60 and is positioned for fluid communication with the interior of the aspiration fluid reservoir.

The valve 18 is positioned downstream from the carrier fluid passage 50 and the aspiration fluid passage 52 in that fluid flows through the passages before entering the valve. The valve 18 is upstream from the vent passage 60 in that fluid passes through the valve before passing through the vent passage. As shown in FIG. 11A, the body 12 defines a valve housing 70, and the valve 18 includes a valve member or rotor 72 which is received in the valve housing. The valve housing 70 has an internal surface defining a generally spherical segment cavity for receiving the valve member 72. The carrier fluid passage outlet opening 50B, the aspiration fluid passage outlet opening 52B, and the vent inlet passage opening 60A are positioned on the internal surface of the valve housing 70 and open into the cavity. Flow through the carrier fluid passage 50, aspiration fluid passage 52, and vent passage 60 is controlled by actuation of the valve member 72.

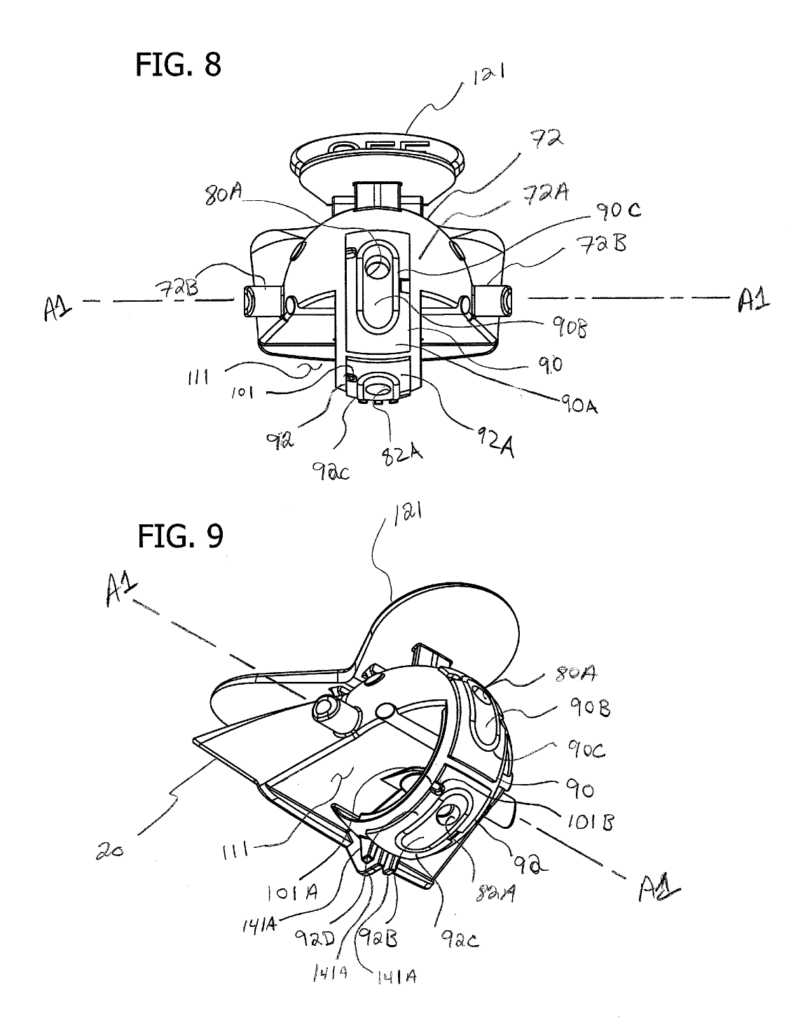

The valve member 72 is shown in closer detail in FIGS. 8 and 9. The valve member 72 includes a generally spherical segment body 72A shaped and configured for being received in the cavity of the valve housing 70. The valve member 72 also includes pins 72B which extend radially outward from the body along a common axis Al about which the valve member may be rotated. The valve housing includes sockets 70A for receiving the pins 72B. As shown in FIG. 7, in the illustrated embodiment, the sockets 70A are defined primarily by openings in the upper body member 30. The sockets also include covers 70B defined by the lower body member 32 which hide the openings and pins 72B and close the openings in the upper body member 30 for retaining the pins in the openings to prevent inadvertent removal of the valve member 72 from the valve housing 70. The pins 72B are rotatable in the sockets 70B for permitting rotation of the valve member 72 about the axis Al with respect to the dispenser body 12.

As mentioned above, the valve 18 may be actuated for selectively permitting fluid flow through the valve. The valve 18 has an “off” position in which the valve is closed and fluid flow through the valve is blocked, and the valve has an “on” or “spray” position in which the valve is open and fluid flow is permitted through the valve. The valve member 72 may be rotated about the axis Al between the “off” and “on” positions. The valve 18 is shown in the “off” position in FIGS. 10A, 11A, and 12A and shown in the “on” position in FIGS. 10B, 11B, and 12B.

As shown in FIG. 11A, the valve member 72 defines a carrier fluid duct 80 and an aspiration fluid duct 82 which correspond to the respective carrier fluid and aspiration fluid passages 50 and 52 in the dispenser body 12. As shown in FIG. 11B, when the valve member 72 is in the “on” position, the carrier fluid duct 80 is in fluid communication with the carrier fluid passage 50, and the aspiration fluid duct 82 is in fluid communication with the aspiration fluid passage 52. Together, the carrier fluid duct 80 and carrier fluid passage 50 form broadly a carrier fluid passageway through the hose end dispenser 10. Moreover, together, the aspiration fluid duct 82 and the aspiration fluid passage 52 form broadly an aspiration fluid passageway through the dispenser 10.

As shown in FIGS. 8 and 9, a carrier fluid duct inlet opening 80A is positioned at an upstream end of the carrier fluid duct 80, and an aspiration fluid duct inlet opening 82A is positioned at an upstream end of the aspiration fluid duct 82. In the illustrated embodiment, the carrier fluid duct inlet opening 80A and aspiration fluid duct inlet opening 82A are provided in respective first and second sealing members 90, 92. The sealing members 90 and 92 are pads received in recesses in the valve member body 72 and are configured for engaging and sliding on the internal surface of the valve housing 70 which defines the spherical cavity. The sealing members 90 and 92 protrude outward from an exterior surface of the valve member body 72. The sealing members each have an engagement surface 90A, 92A for engaging the internal surface of the valve housing 70. The engagement surfaces 90A and 92A have a curvature corresponding to the curvature of the internal surface of the valve housing 70. The sealing members 90, 92 may be formed as separate pieces from the valve member body 72 and then be inserted into the recesses, or the sealing members may be formed on the valve member body in a molding operation. The sealing members 90 and 92 are desirably formed of a material which is compressible, resilient, and at least slightly softer than the material from which the valve housing 70 is formed. For example, the sealing members 90 and 92 may be formed of a suitable material including but not limited to polymeric materials, ethylene-vinyl acetate materials, and rubber-based materials. When the valve member 72 is in the “on” position, the carrier fluid duct inlet opening 80A is positioned in register with the carrier fluid passage outlet opening 50B and the aspiration fluid duct inlet opening 82A is positioned in register with the aspiration fluid passage outlet opening 52B. When the valve member 72 is in the “off” position, sealing segments 90B, 92B of respective sealing members 90, 92 are positioned over and cover the carrier fluid passage outlet opening 50B and the aspiration fluid passage outlet opening 52B for blocking fluid flow through the passages 80, 82.

As shown in FIGS. 8 and 9, the sealing members 90, 92 include raised leak guards 90C, 92C protruding slightly outward from the engagement surfaces 90A, 92A. More specifically, the leak guards 90C, 92C are loops which circumscribe respective duct openings 80A, 82A and sealing segments 90B, 92B. The leak guards 90C, 92C provide enhanced engagement (i.e., a tighter fit than the engagement surfaces) between the sealing members 90, 92 and the interior surface of the valve housing 70. Desirably, the leak guards 90C, 92C prevent fluid from passing out of the valve 18 between the valve member 72 and the valve housing 70. More specifically, any fluid which moves between the valve member 72 and the internal surface of the valve housing 70 is desirably contained within the space circumscribed by the loops 90C, 92C so the fluid ultimately passes through respective ducts 80, 82 rather than laterally outward between the valve member 72 and the valve housing 70.

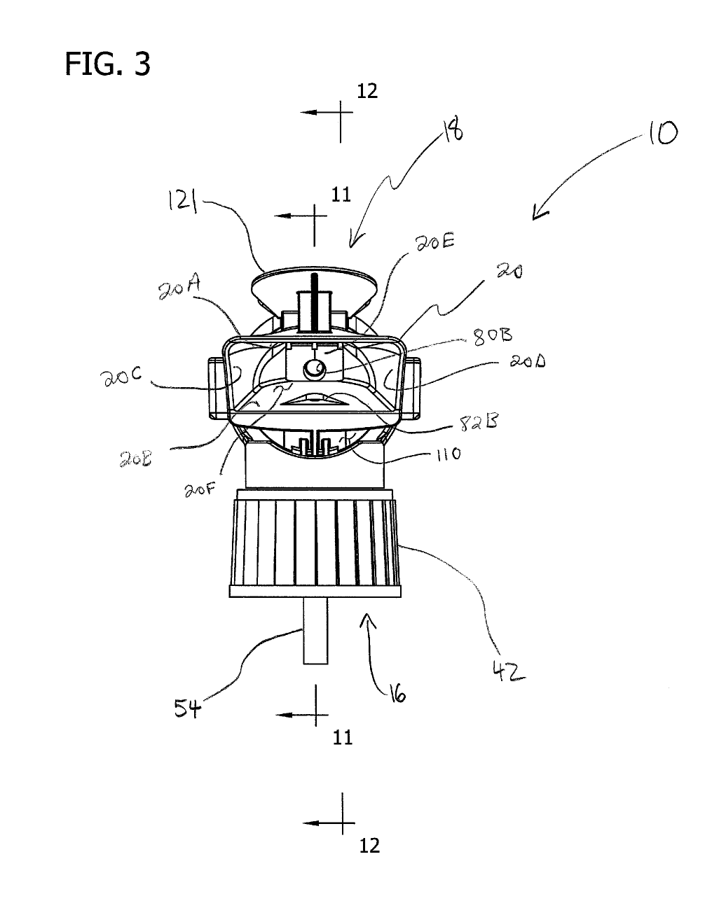

As also shown in FIGS. 8 and 9, the valve member includes a vent duct 101 corresponding to the vent passage 60 in the dispenser body 12. Together, the vent duct 101 and vent passage 60 broadly form a vent passageway through the dispenser 10. The vent duct 101 has a vent duct inlet opening 101A and a vent duct outlet opening 101B. In the illustrated embodiment, the vent duct 101 is provided in the form of a notch or channel in the second sealing member 92 opening one side of the second sealing member to atmosphere. The vent duct inlet opening 101A is positioned on a side surface of the second sealing member 92, and the vent duct outlet opening 101B is positioned on the engagement surface 92A of the second sealing member. When the valve member 72 is in the “on” position, the vent duct outlet opening 101B is positioned in register with the vent passage inlet opening 60A such that the vent duct 101 and vent passage 60 are in fluid communication with each other (FIGS. 12B and 12B′). Thus, the interior of the aspiration fluid reservoir is in communication with the open atmosphere. The vent duct 101 is in continuous fluid communication with open atmosphere via a space 111 between the body of the valve member 72 and the internal surface of the valve housing 70 which opens out of the valve housing at a front end of the valve housing below the nozzle 20 (FIG. 3). When the valve member 72 is in the “off” position, a sealing segment 92D of the second sealing member 92 is positioned over and covers the vent passage inlet opening 60A for blocking fluid flow through the vent passage 60 (FIG. 11B).

As is now apparent, rotation of the valve member 72 to the “on” position opens simultaneously the carrier fluid, aspiration fluid, and vent passageways to permit fluid flow therethrough. Moreover, rotation of the valve member 72 to the “off” position closes simultaneously the carrier fluid, aspiration fluid, and vent passageways to block fluid flow therethrough.

The valve member includes an integrally formed rocker lever 121 for facilitating rotation of the valve member 72 between the “off” and “on” positions. In the illustrated embodiment, the lever 121 is positioned on an upper end of the valve member 72 and at an upper end of the dispenser body 12. The lever 121 is positioned with respect to the valve member body 72 such that a plane oriented perpendicularly with respect to the axis of rotation A1 (e.g., the plane including line 11-11 in FIG. 3) extends through both the valve member body and the lever. In other words, the lever 121 extends radially outward from the valve member 72 in a direction along a plane (e.g., the plane including line 11-11 in FIG. 3) which is perpendicular to the axis of rotation Al of the valve member and which passes through the valve member and the lever. The lever 121 is configured for enabling one-handed operation of the dispenser 10. In other words, the lever 121 is positioned so a user may actuate the lever with the same hand with which the user holds the main portion of the dispenser body 12A. The lever 121 is conveniently accessible by a thumb of a user when the other four fingers of the user's hand are gripping the main portion of the dispenser body 12A.

The lever 121 includes first and second actuation members or thumb engagement members 131, 133 for facilitating rocking actuation of the lever. The actuation members 131, 133 extend radially outward from the valve member body 72 with respect to the axis of rotation Al. The first and second actuation members 131, 133 each have a generally flat major actuation surface 131A, 133A which is sized for receiving the user's thumb and which face upward or in a substantially vertical direction away from the upper end of the dispenser body 12. The actuation surfaces 131A, 133A face away from the valve and form a generally V-shape. Opposite surfaces of the actuation members 131, 133 face the valve. The first actuation member 131 may be pressed (e.g., by engagement of the user's thumb with the first actuation surface) for rotating the valve member 72 to the “on” or “spray” position, and the second actuation member 133 may be pressed (e.g., by engagement of the user's thumb with the second actuation surface) for rotating the valve member to the “off” position. The lever 121 is movable by rocking rotation between the “on” and “off” positions. Accordingly, in the illustrated embodiment, the first actuation member 131 includes the label “SPRAY” on its actuation surface 131A, and the second actuation member 133 includes the label “OFF” on its actuation surface 133A.

The valve 18 includes stops 141, 143, 145, 147 for limiting rotational movement of the valve member 72 in the valve housing 70 about axis Al. For example, as shown in FIGS. 8, 9, and 11A, the stop 141 includes arms 141A extending from a forward lower surface of the valve member 72. When the valve member 72 is in the “off” position, the arms 141A engage an upward facing portion of the interior surface of the valve housing 70 for preventing rotation of the valve member to a position beyond the “off” position.

As shown in FIG. 10B, the valve member also includes a stop 143 in the form of a lower surface of the lever 121, and more specifically a lower surface 143A of the first actuation member 131, which is configured for engaging an upper surface 143B of the dispenser body 12. When the valve member 72 is in the “on” position, the lower surface of the first actuation member 143A engages the upper surface of the dispenser body 143B for preventing rotation of the valve member to a position beyond the “on” position.

The valve includes stops 145, 147 in the form of protrusions 145A, 147A extending outward from the valve member 72 which are received in arcuate segment guides or tracks 145B, 147B in the valve housing 70. In the illustrated embodiment, four of these stops are provided. More specifically, two stops 145, 147 are provided on each side of the valve, one (145) being positioned at an upper end of the valve 18, and one (147) being positioned at a lower end of the valve. The stops at the lower end of the valve 147 are normally covered by the lower body member 32 but are exposed in FIGS. 10A and 10B because the lower body member is removed from the upper body member 30. As shown in FIG. 10A, when the valve member 72 is in the “off” position, the protrusions 145A, 147A engage lower ends of the arcuate segment guides 145B, 147B for preventing rotation of the valve member to a position beyond the “off” position. As shown in FIG. 10B, when the valve member 72 is in the “on” position, the protrusions 145A, 147A engage upper ends of the arcuate segment guides 145B, 147B for preventing rotation of the valve member to a position beyond the “on” position. The stops 145, 147 stabilize the valve member 72 in the valve housing 70 for maintaining contact of the sealing members 90, 92 against the internal surface of the valve housing to prevent fluid from leaking between the valve member and the valve housing. In particular, the stops 145, 147 are positioned to counteract force which may tend to move the sealing members 90, 92 away from the fluid outlet openings 50 B, 52B in the valve housing 70. For example, when the valve member 72 is in the “off” position, as shown in FIG. 10A, if the stops 145, 147 were not provided, pressure on the second actuation member 133 may cause the arms 141A to act as cams which cause the sealing members 90, 92 to at least partially disengage the internal surface of the valve housing 70 and thus cause fluid to leak between the valve member 72 and the valve housing. In another aspect of the stops 145, 147, the arcuate segment guides 145B, 147B of the stops include shoulders or detents 145C, 147C on lower sides of the guides which interfere with the movement of the protrusions 145A, 147A as the valve member 72 is moved between the “off” and “on” positions. More specifically, the detents 145C, 147C act as “over center” devices. As the protrusions 145A, 147A move from the upper ends of the arcuate segment guides 145B, 147B (the “off” position shown in FIG. 10A′) to the lower ends of the arcuate segment guides (the “on” position shown in FIG. 10B), the protrusions move “over center” over the detents 145C, 147C such that the protrusions are then biased toward the lower ends of the guides. This action of the protrusions 145A, 147A passing “over center” toward the lower ends of the guides 145B, 147B may be described as the valve member “snapping” into place into the “on” position. The detents 145C, 147C may also bias the valve member 72 toward the “off” position when the protrusions 145A, 147A pass “over center” over the detents toward the upper ends of the arcuate segment guides 145B, 147B.

Valves having other configurations may be used without departing from the scope of the present invention. For example, the valve may have a generally cylindrical construction instead of a generally spherical construction. Other numbers of sealing numbers may be used. Vent ducts having other configurations may be used. More than one valve may be provided for opening and closing the carrier fluid, aspiration fluid, and vent passageways separately. Moreover, valves which are adjustable for adjusting the amount of aspiration fluid siphoned per unit carrier fluid may be used. In addition, stops having other configurations or other numbers of stops may be used.

The nozzle 20 is positioned downstream from the valve 18. More specifically, the nozzle 20 is attached or connected directly to the valve member 72 and is movable conjointly with the valve member. In other words, the nozzle 20 rotates downward about axis Al when the valve member 72 is moved toward the “on” position, and the nozzle rotates upward about axis Al when the valve member is moved toward the “off” position. As shown in FIG. 3, in the illustrated embodiment, the nozzle 20 is in the form of a hood having upper and lower walls 20A, 20B, opposite side walls 20C, 20D, a back wall 20E, and an open front 20F. The carrier fluid duct 80 of the valve member 72 opens into the nozzle 20 through a carrier fluid duct outlet 80B opening in the back wall 20E of the nozzle. The aspiration fluid duct 82 opens into the nozzle 20 through a graduated aspiration fluid duct outlet 82B opening in the lower wall 20B of the nozzle 20 in front of the carrier fluid duct outlet opening 80B. The side walls 20C, 20D of the nozzle 20 are angled away from each other, and the upper and lower walls 20A, 20B are angled away from each other, which provides the nozzle with a flow area adjacent the open front 20F which is larger than a flow area adjacent the rear wall 20E. Flow of carrier fluid through the nozzle 20 toward the open end 20F creates suction which causes the aspiration fluid to be siphoned or aspirated from the reservoir into the nozzle and mixed with the carrier fluid. The mixed aspiration fluid and carrier fluid are sprayed out of the open end of the nozzle 20F.

Nozzles having other configurations may be used without departing from the scope of the present invention. For example, nozzles configured for dispensing a continuous stream of fluid rather than nozzles which dispense liquid in the form of a spray. Moreover, nozzles may be used which dispense the mixed aspiration fluid and carrier fluid in the form of a foam.

A lock 161 may be provided for maintaining the valve 18 in the “off” position until it is desired to move the valve to the “on” position. In the illustrated embodiment, a lock 161 is provided in the form of a removable or frangible tab. The tab 161 is shown on the hose end dispenser 10 in FIGS. 1-6. The tab 161 is removed from the hose end dispenser 10 in FIGS. 10-12. The tab 161 is positioned on an upper side of the dispenser body 12 and may be formed in the same molding operation as the upper body member 30. The tab 161 is connected to the upper body member 30 by relatively small bridges 161A which may be easily fractured for removing the tab. The tab 161 has a first portion 161B which extends below a portion of the lever 121 when the lever is in its “off” position. The first portion 161B is positioned for engaging a lower side of the lever 121 and the upper side of the housing 70 for preventing the valve member 72 from being inadvertently moved to the “on” position. The tab 161 has a second portion 161C which extends out from under the lever 121 for gripping by a hand of a user for removing the tab from the body 12. For example, the tab 161 may remain in locking position while the dispenser 10 is displayed for sale and be removed by a user when ready for use.

In use, the dispenser 10 is connected to a source of carrier fluid such as a garden hose, connected to a source of aspiration fluid such as a reservoir, and the valve 18 is actuated to control dispensing of the mixed carrier fluid and aspiration fluid. As explained above, the dispenser 10 is configured for convenient one-handed operation in that the dispenser body 12 may be held by the same hand that is used to actuate the valve 18.

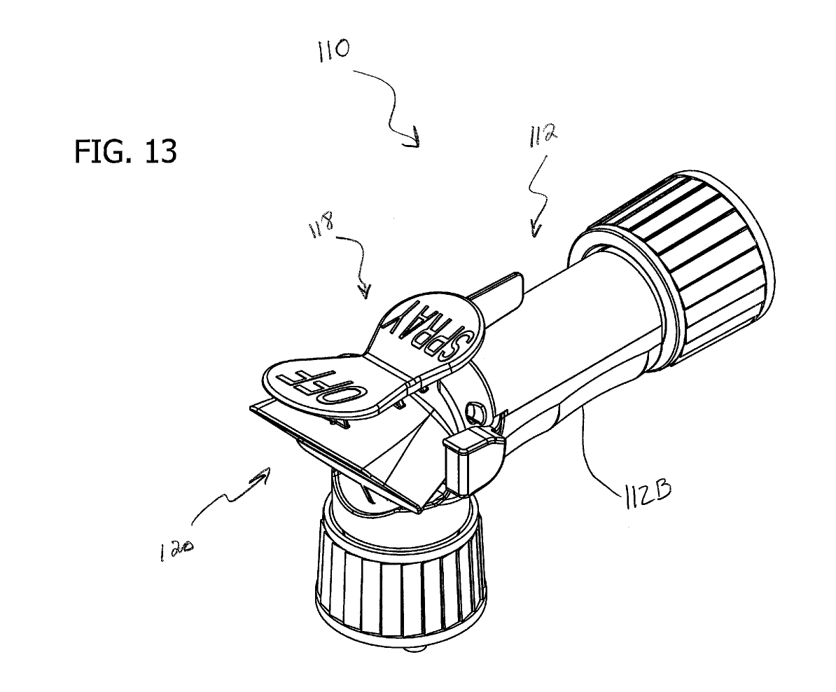

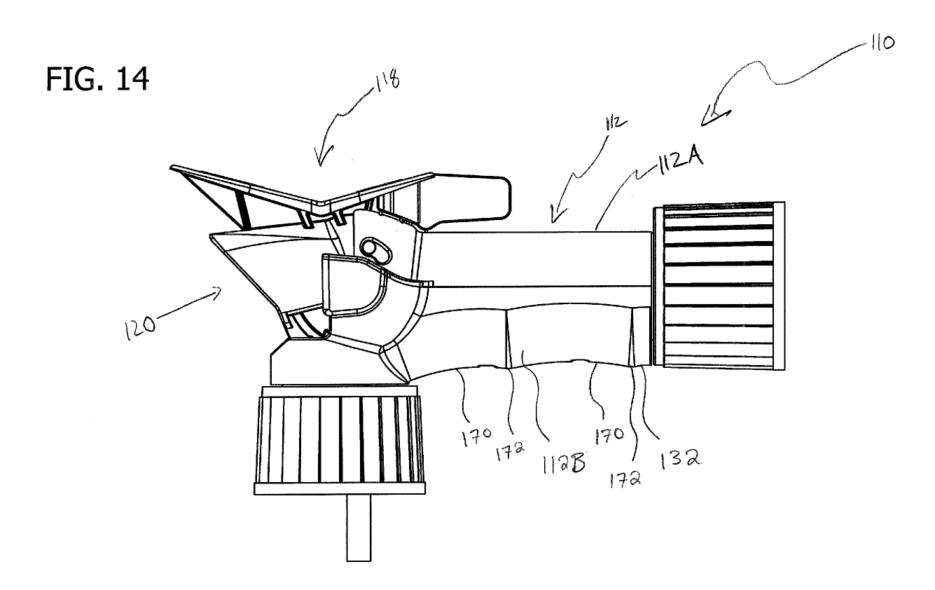

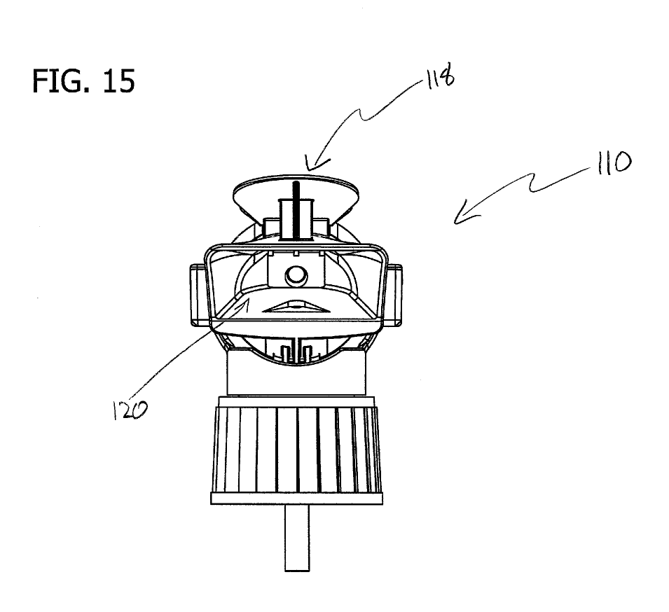

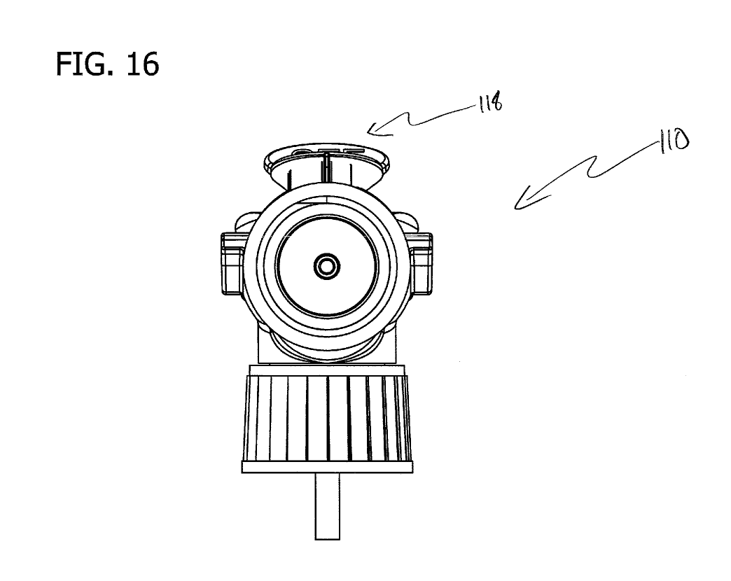

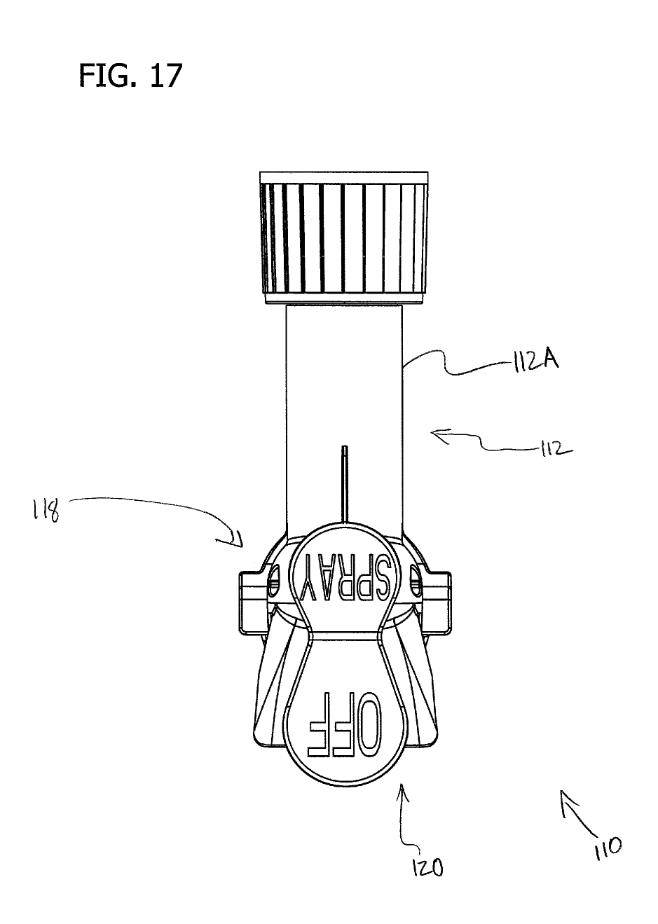

A dispenser 110 of a second embodiment of the present invention is illustrated in FIGS. 13-18. The dispenser 110 is similar to the dispenser 10 of the first embodiment, and corresponding parts are indicated by corresponding reference numbers, plus 100. For example, the dispenser 110 includes a body 112, a valve 118, and a nozzle 120. In this embodiment, the body 112 has a differently configured gripping surface 112B. More specifically, the gripping surface 112B provided on the lower body member 132 includes indentations 170 for providing the gripping surface with a contour for accommodating two fingers wrapped on the main portion of the body. The gripping surface 112B also includes ribs 172 which would be positioned between fingers wrapped on the gripping surface. The dispenser 110 of this second embodiment is otherwise identical to and functions the same as the dispenser 10 of the first embodiment.

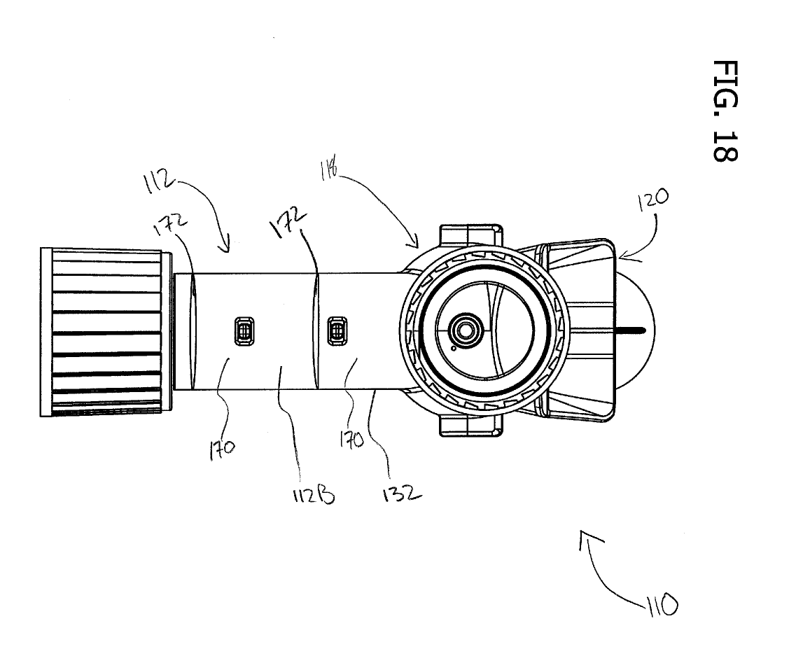

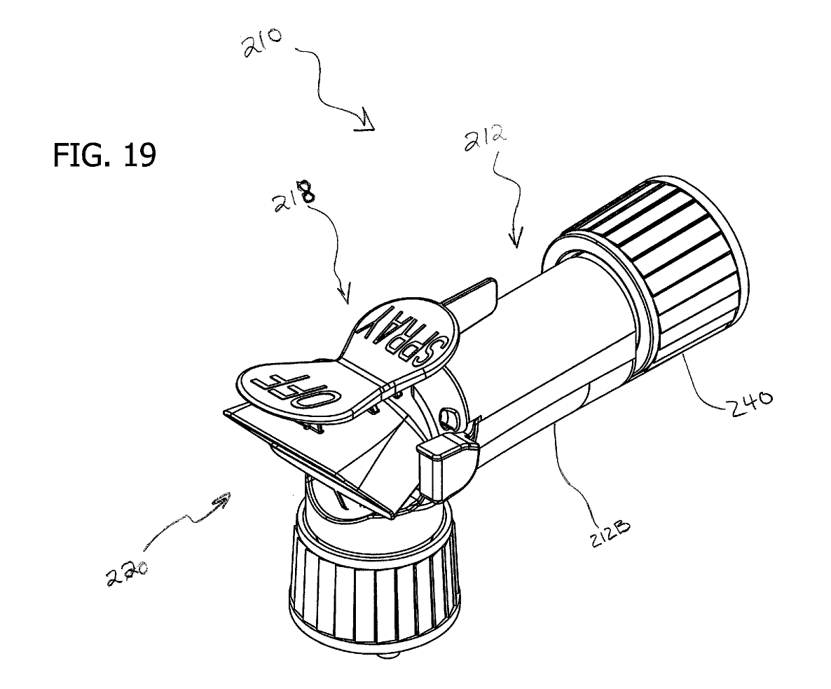

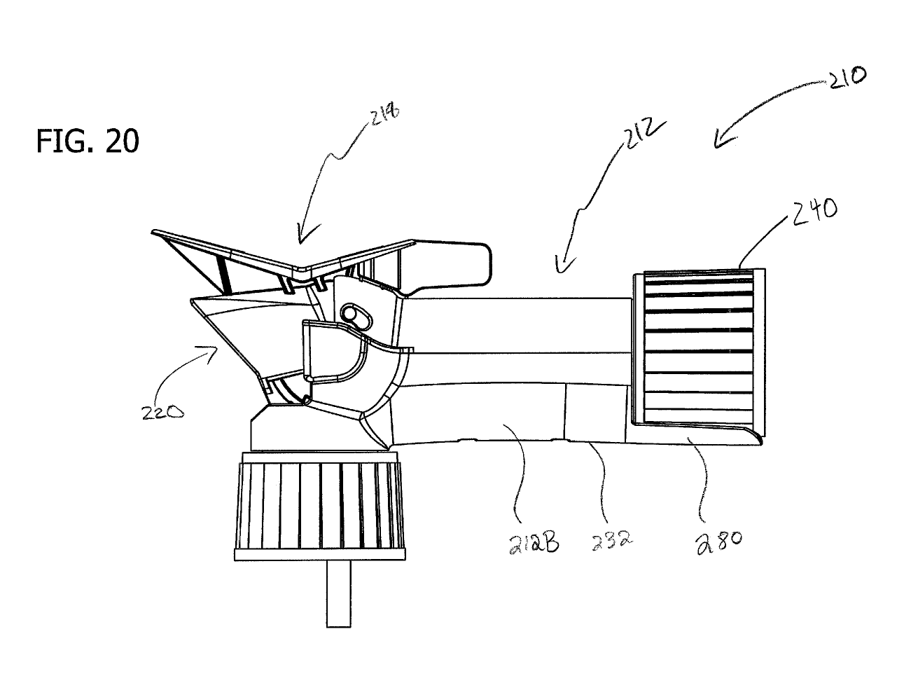

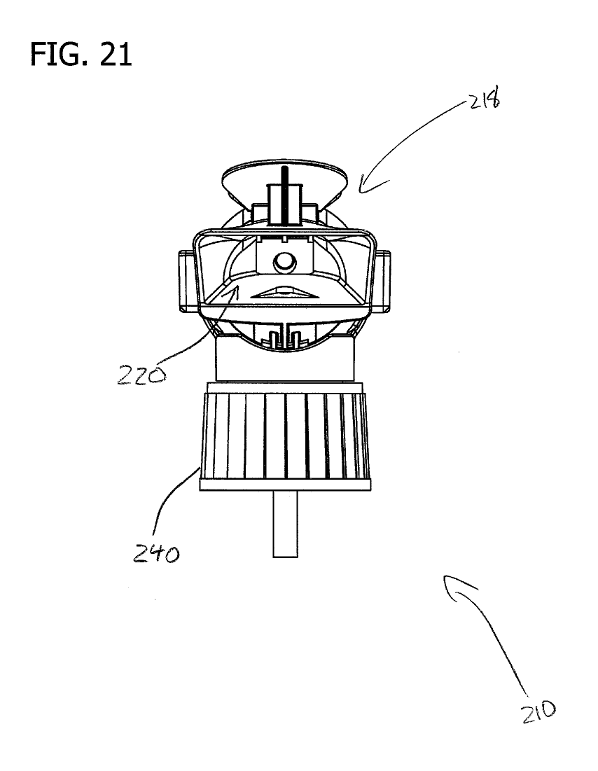

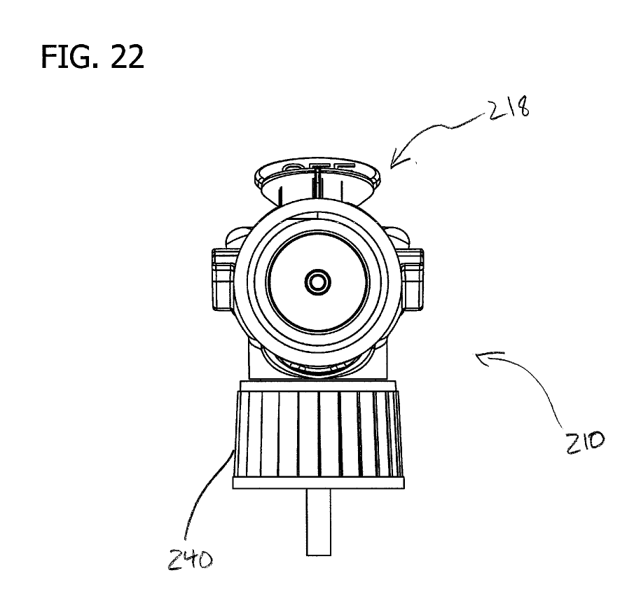

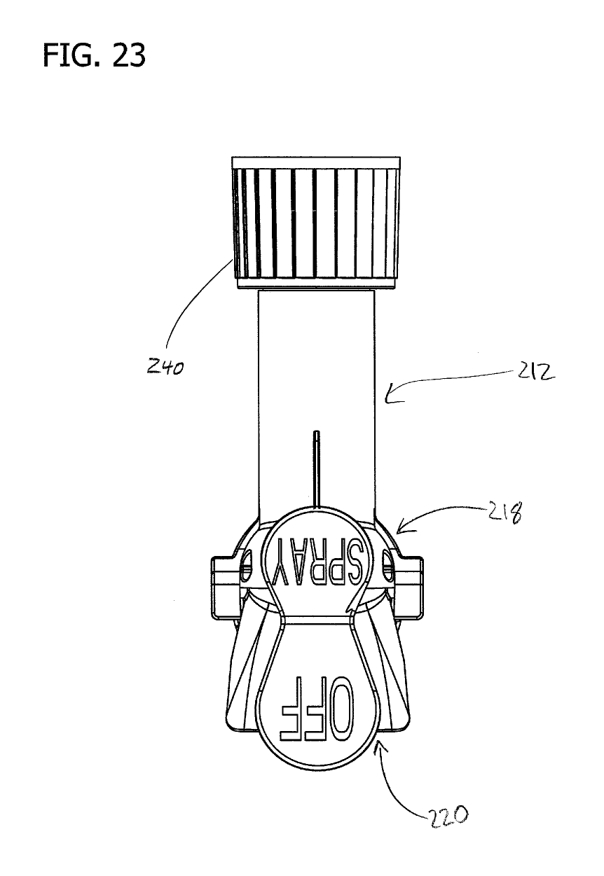

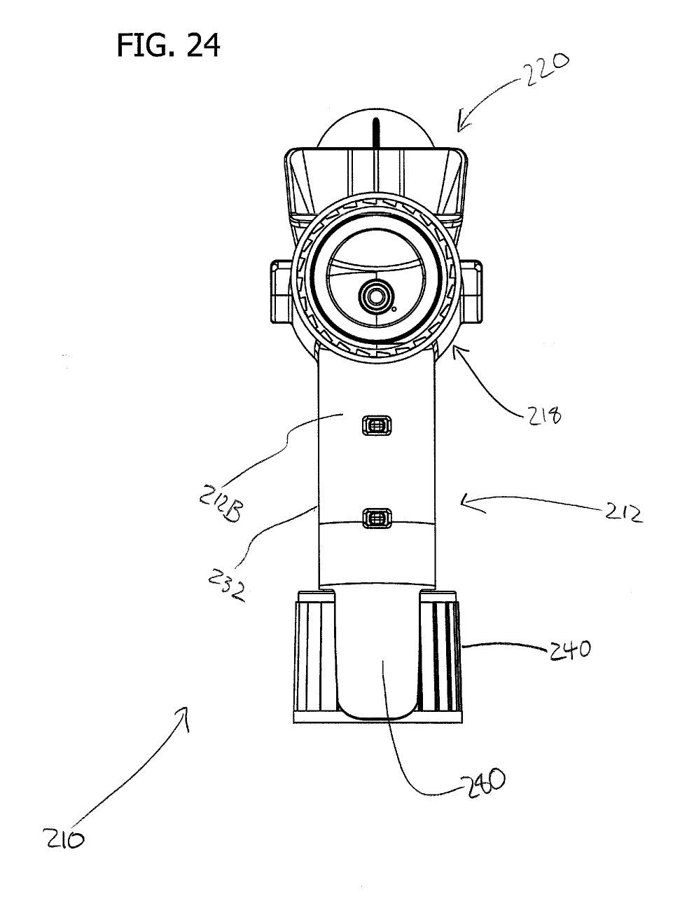

A dispenser 210 of a third embodiment of the present invention is illustrated in FIGS. 19-24. The dispenser 210 is similar to the dispenser 10 of the first embodiment, and corresponding parts are indicated by corresponding reference numbers, plus 200. For example, the dispenser 210 includes a body 212, a valve 218, and a nozzle 220. In this embodiment, the body 212 has a differently configured gripping surface 212B. More specifically, the gripping surface 212B provided on the lower body member 232 includes an extension 280 which extends below a lower surface of the internally threaded connecting sleeve 240 for connecting to a source of carrier fluid. The extension 280 provides a surface under the sleeve 240 which is smoother than and thus more comfortable for gripping than the outer stepped or ribbed surface of the sleeve. The gripping surface 212B is extended to accommodate more fingers on the gripping surface than the gripping surface 12B of the first embodiment. The dispenser 210 of this third embodiment is otherwise identical to and functions the same as the dispenser 10 of the first embodiment.

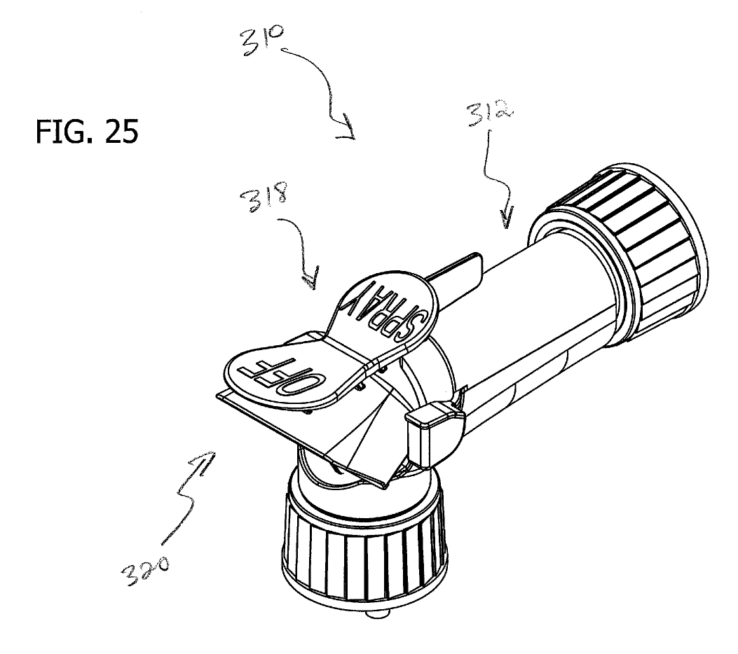

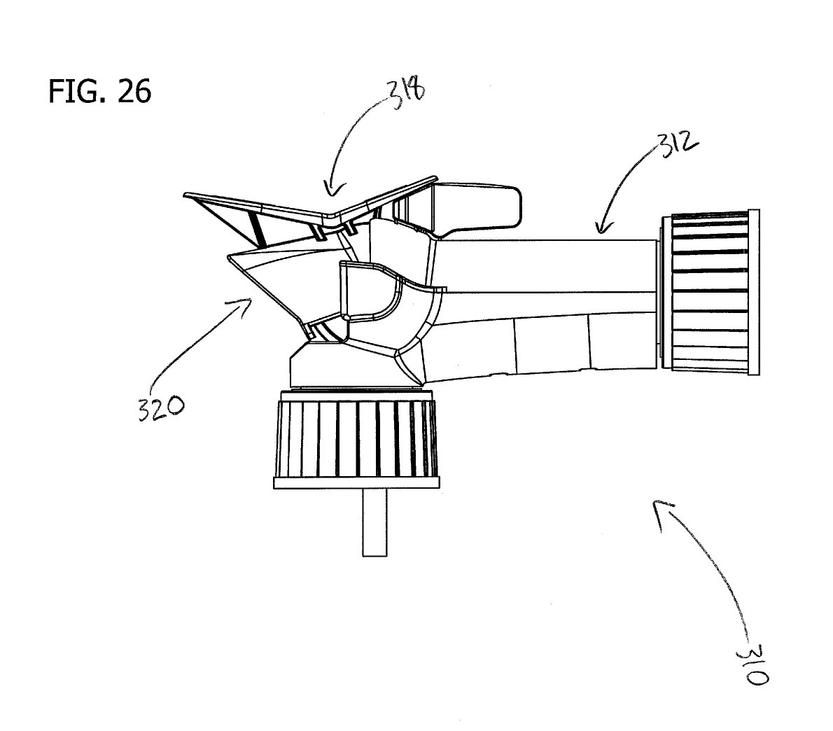

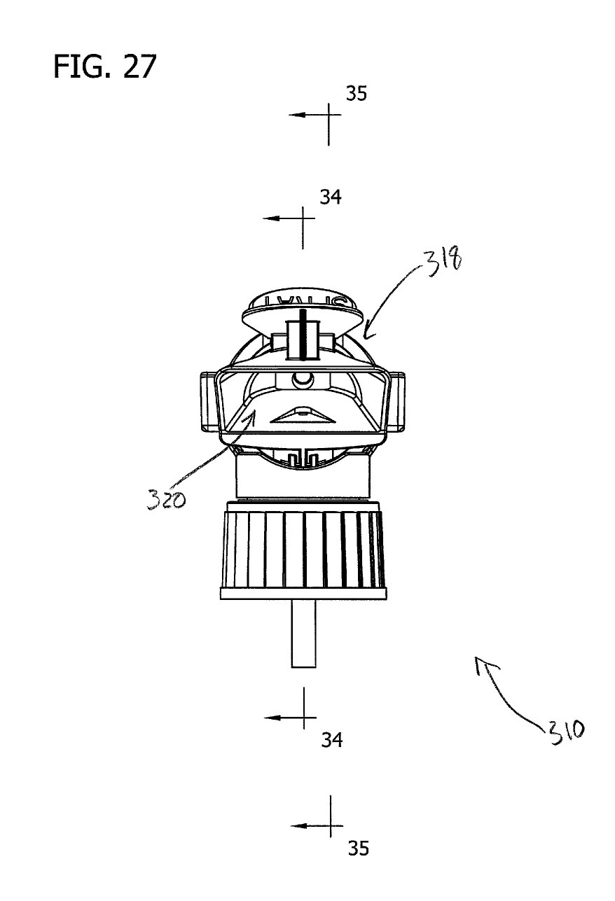

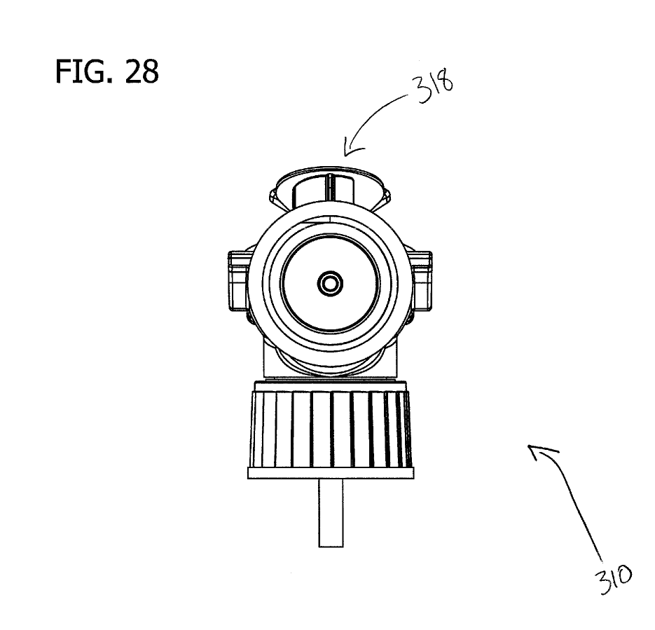

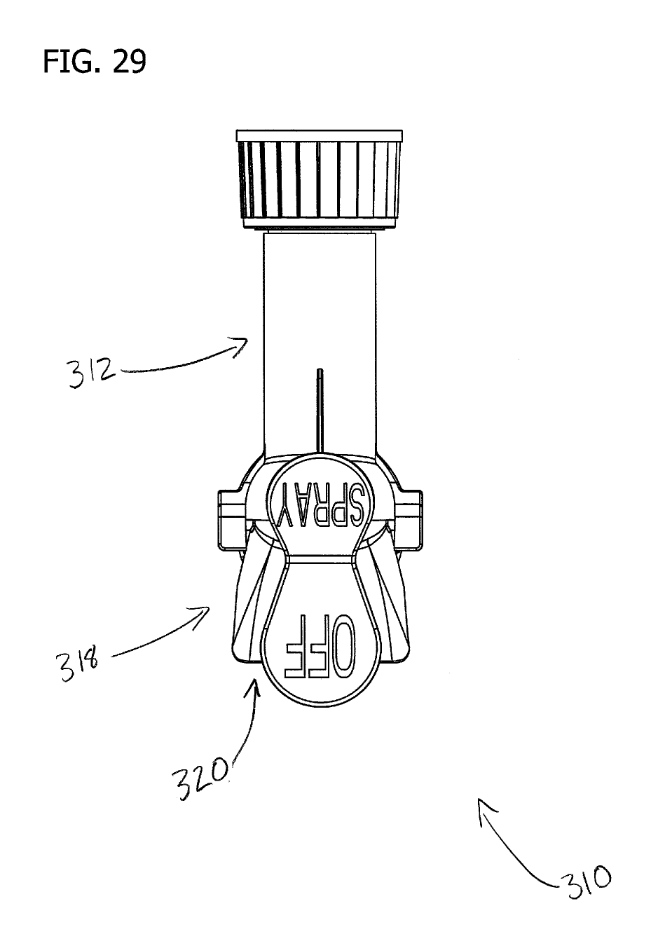

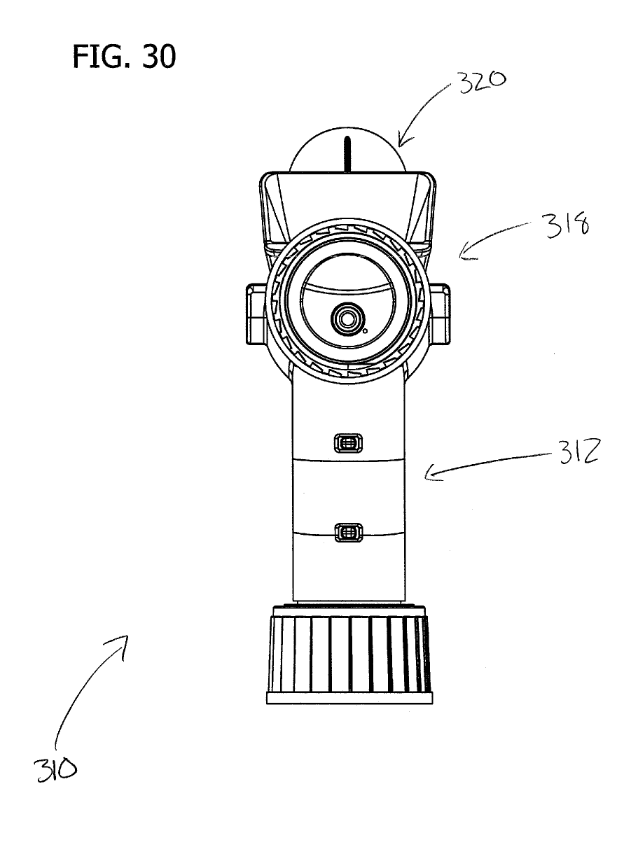

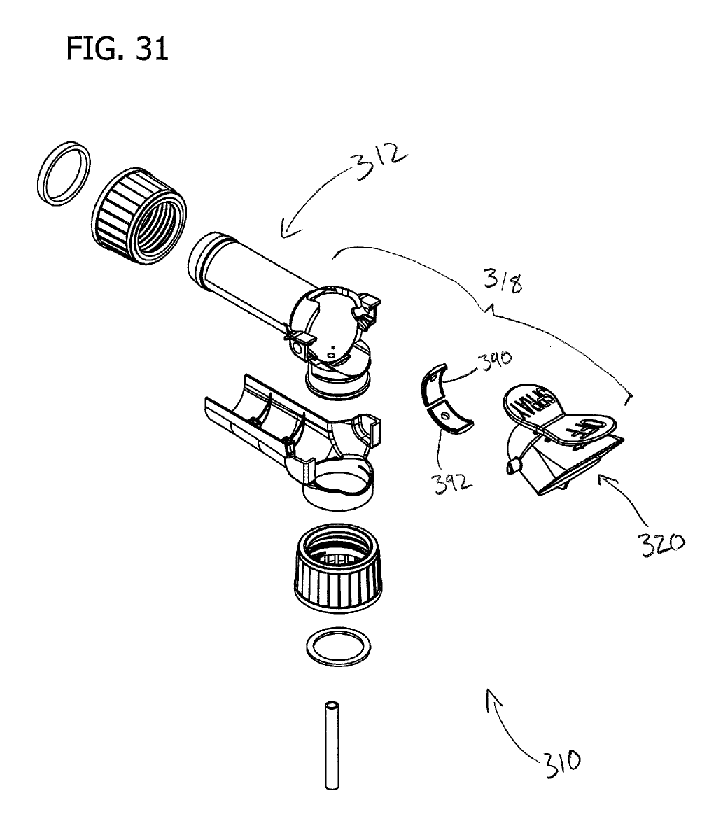

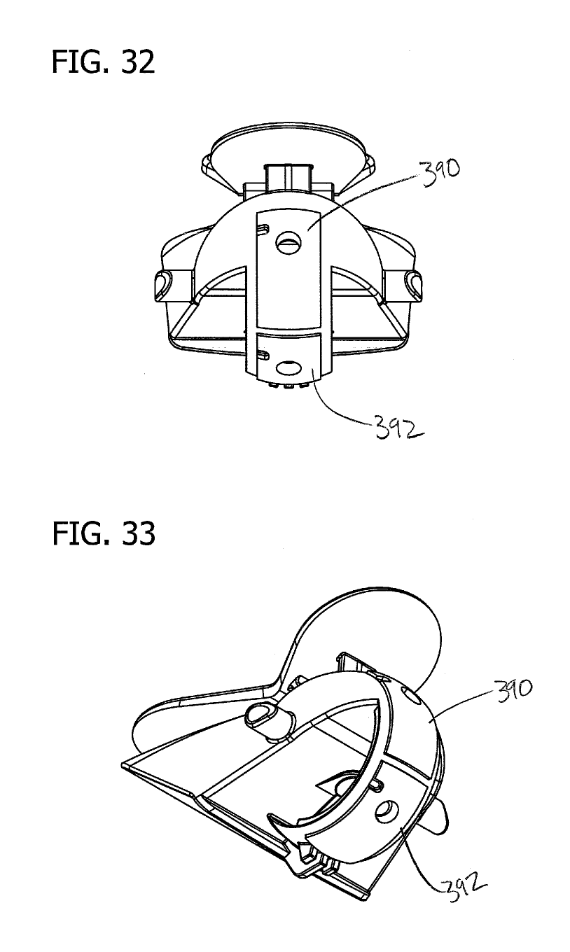

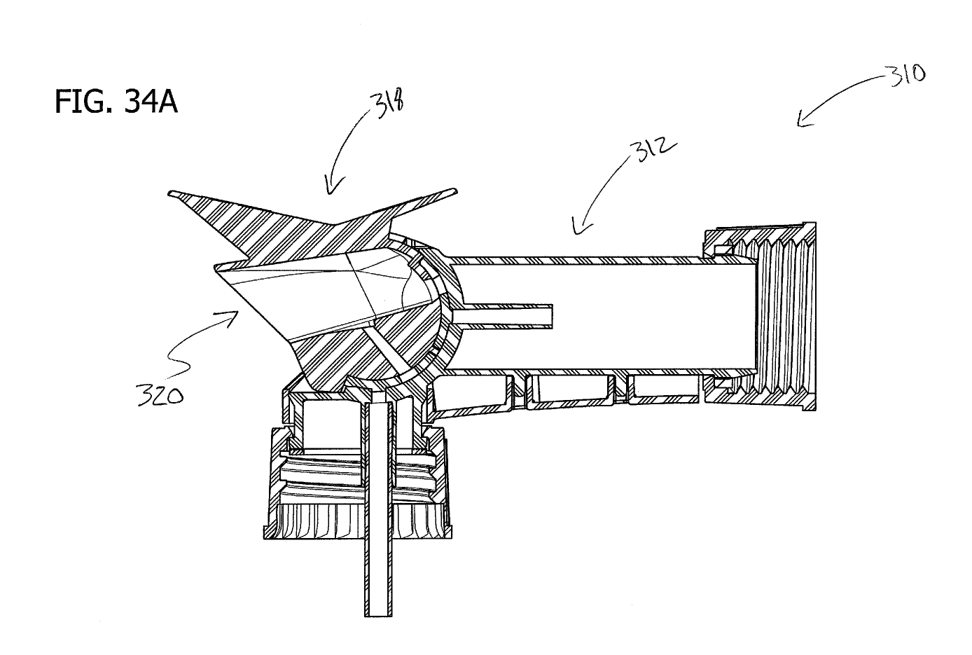

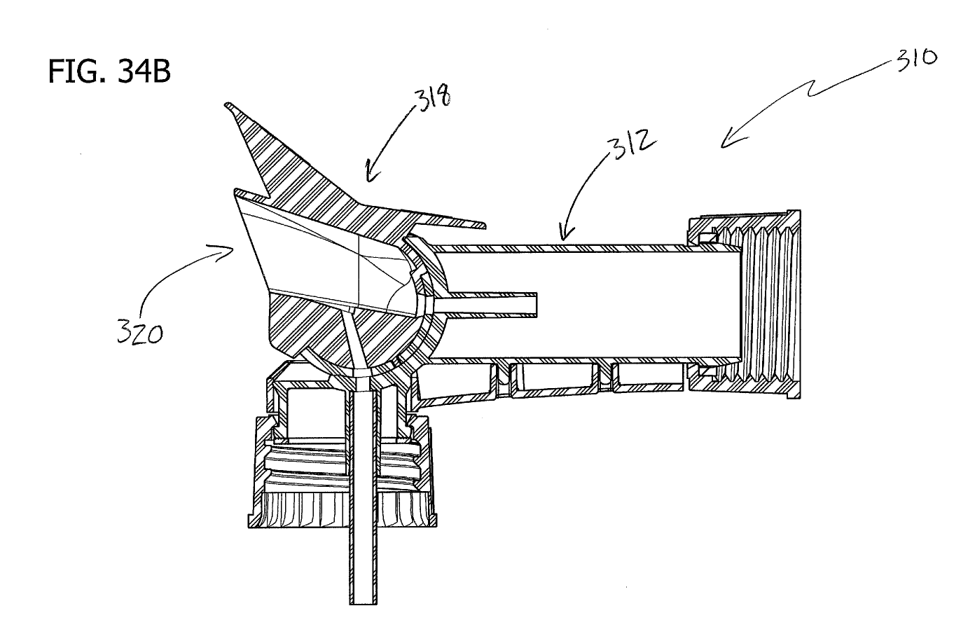

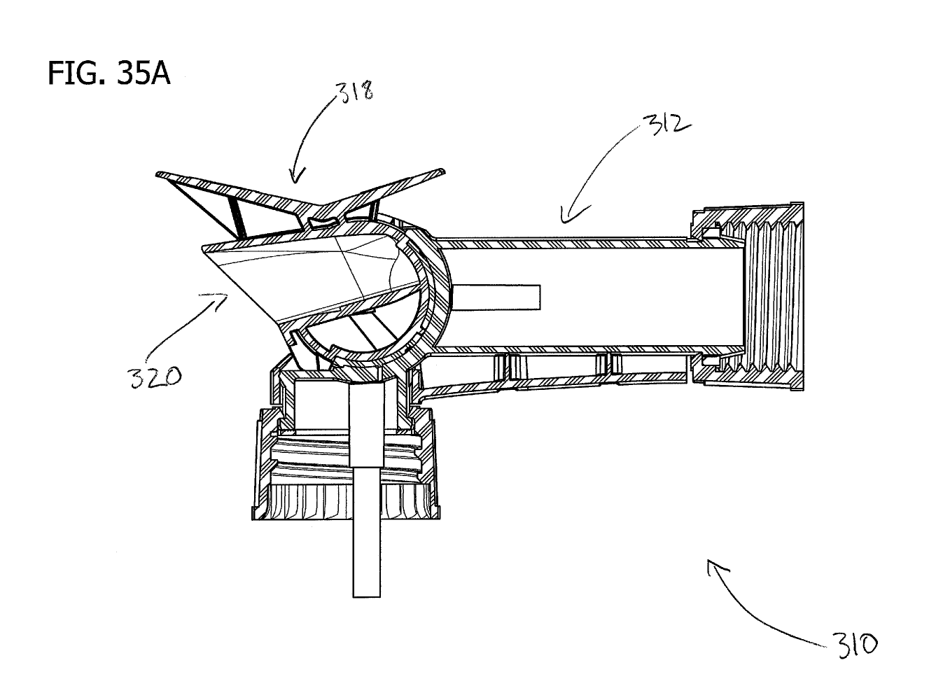

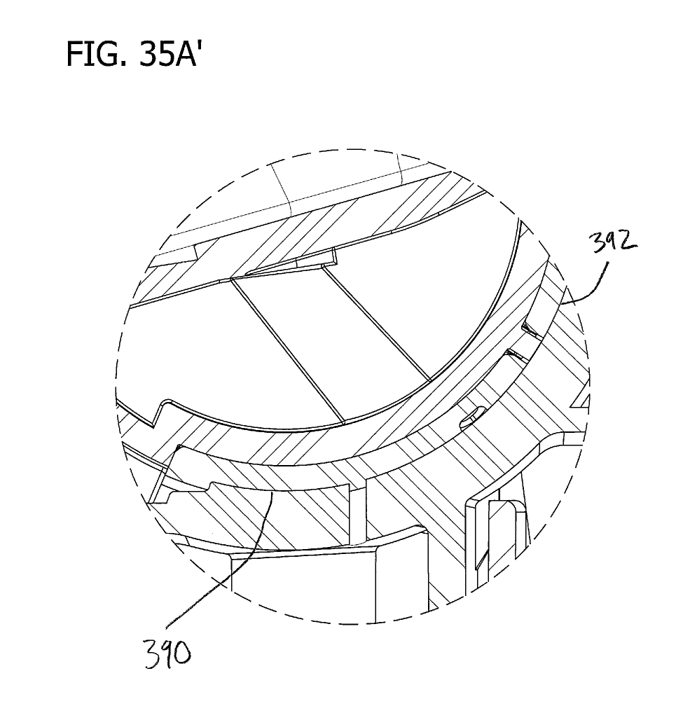

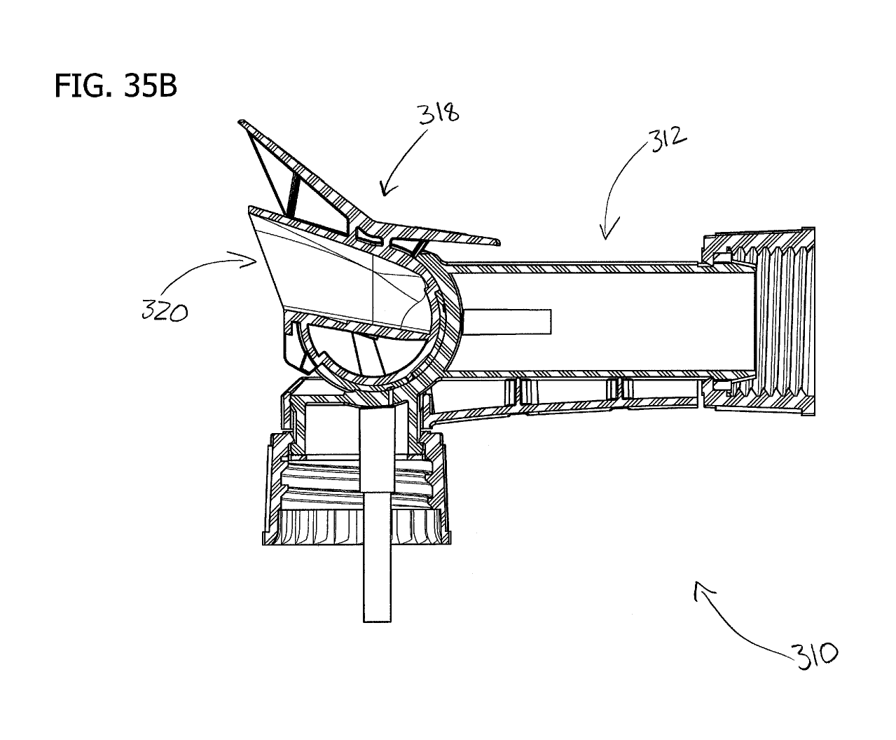

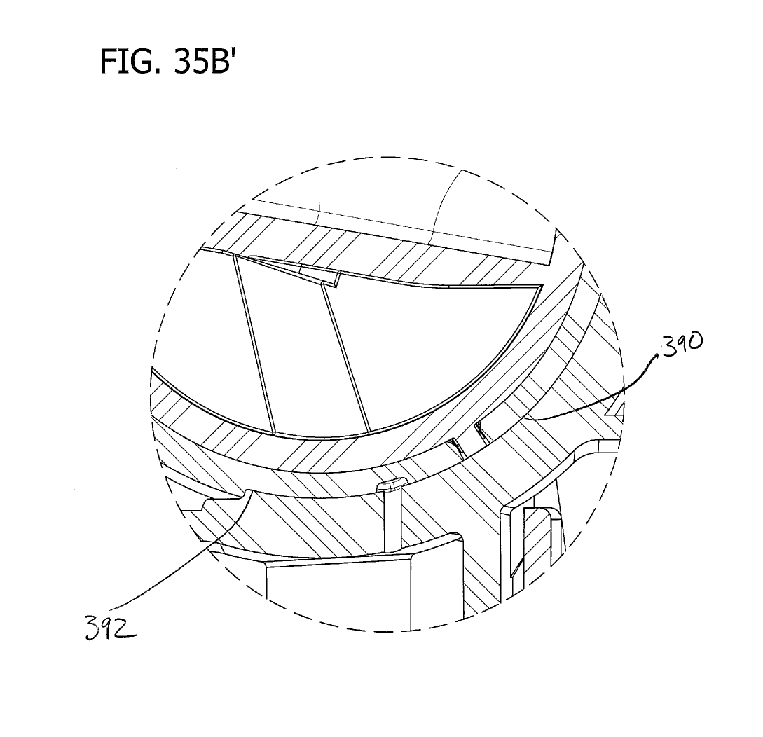

A dispenser 310 of a fourth embodiment of the present invention is illustrated in FIGS. 25-35. The dispenser 310 is similar to the dispenser 10 of the first embodiment, and corresponding parts are indicated by corresponding reference numbers, plus 300. For example, the dispenser includes a body 312, a valve 318, and a nozzle 320. In this embodiment, the valve 318 does not include notch-and-guide type stops such as the stops 145, 147 of the first embodiment. In addition, the dispenser 310 does not include a leak guard such as the leak guards 90C, 92C of the first embodiment. The dispenser 310 is otherwise identical to and functions the same as the dispenser 10 of the first embodiment.

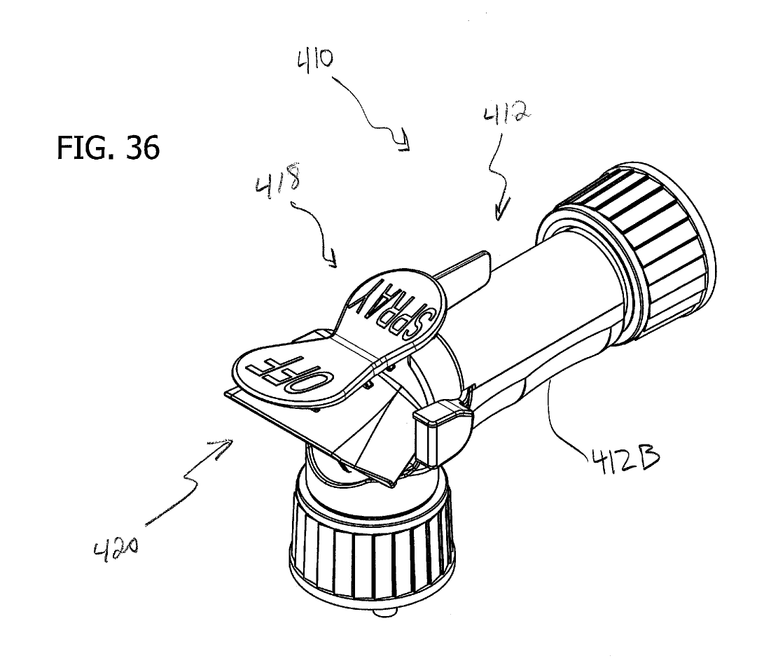

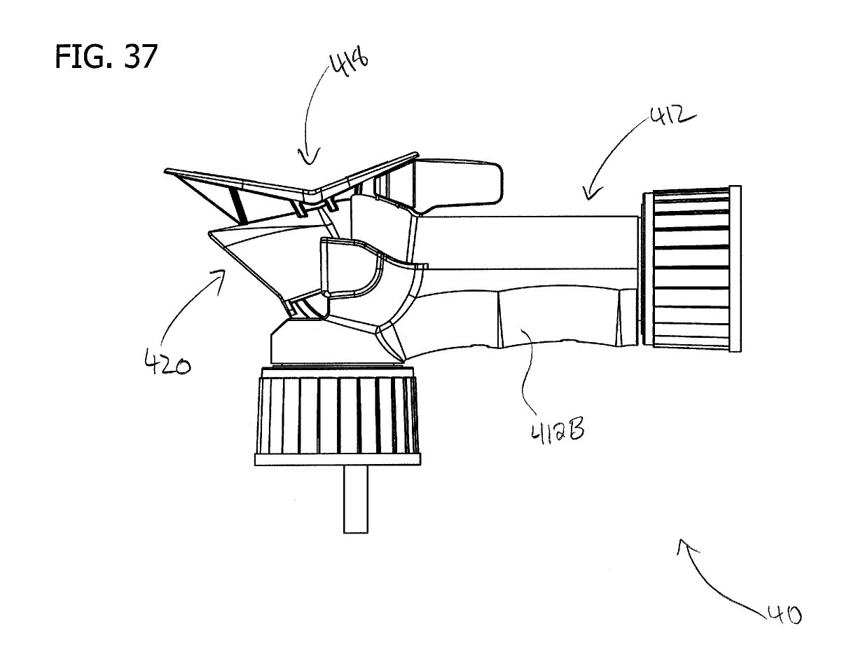

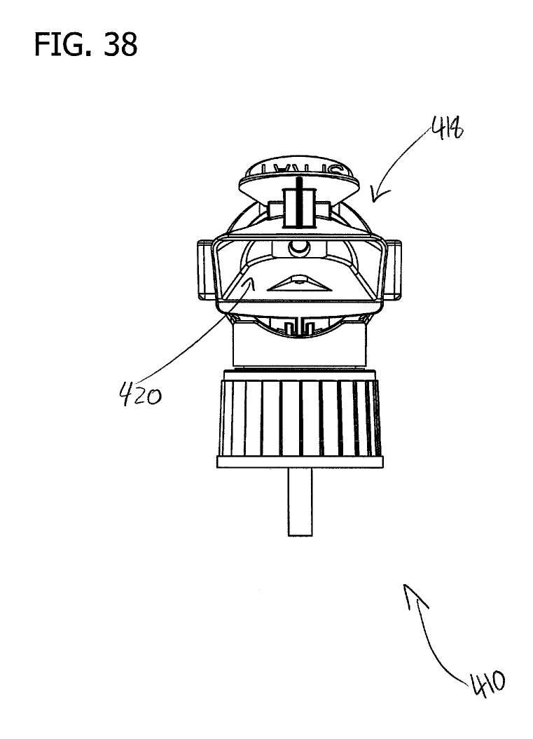

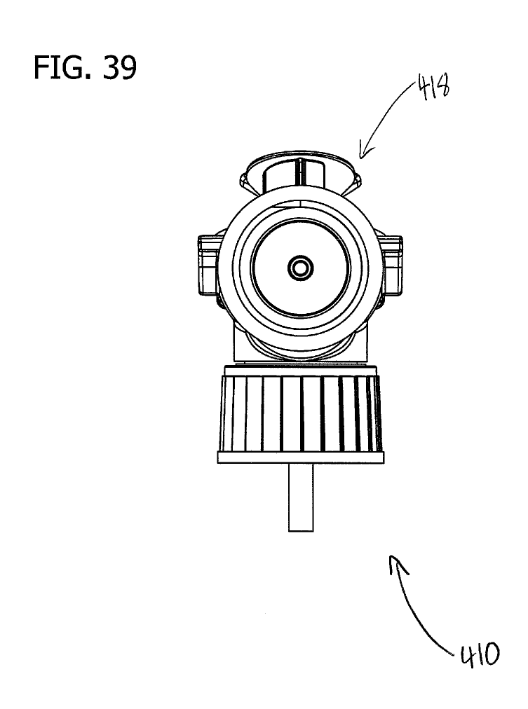

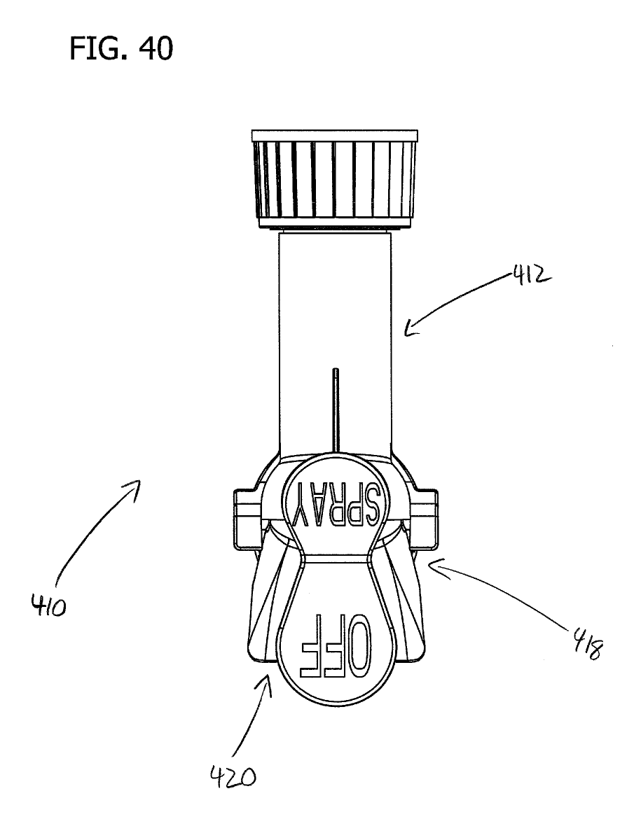

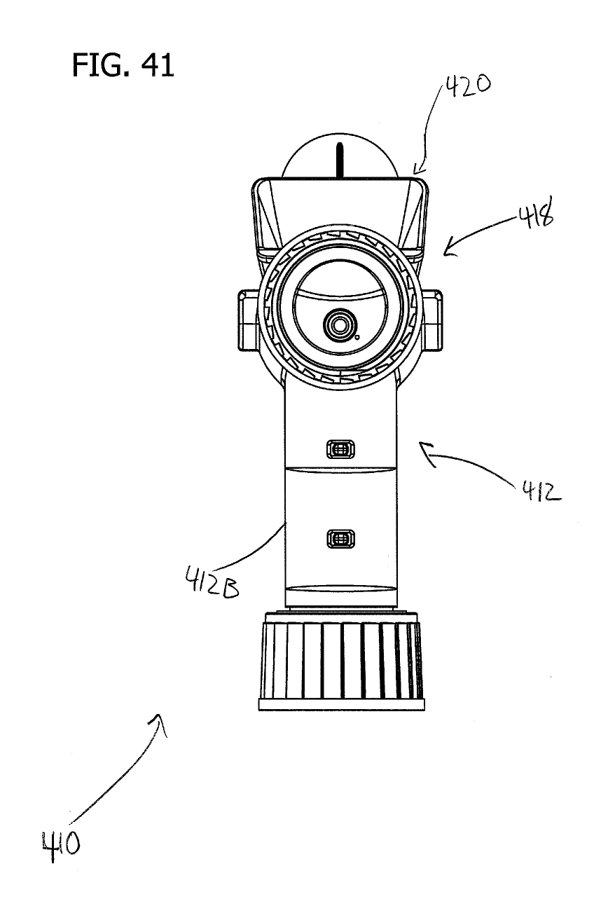

A dispenser 410 of a fifth embodiment of the present invention is illustrated in FIGS. 36-41. The dispenser 410 is similar to the dispenser 10 of the first embodiment, and corresponding parts are indicated by corresponding reference numbers, plus 400. For example, the dispenser 410 includes a body 412, a valve 418, and a nozzle 420. In this embodiment, the valve does not include notch-and-guide stops such as the stops 145, 147 of the first embodiment. In addition, in this fifth embodiment, the dispenser does not include a leak guard such as the leak guards 90C, 92C of the first embodiment. Moreover, the dispenser 410 includes a gripping surface 412B substantially the same as the gripping surface 12B provided in the second embodiment. The dispenser 410 is otherwise identical to and functions the same as the dispenser 10 of the first embodiment.

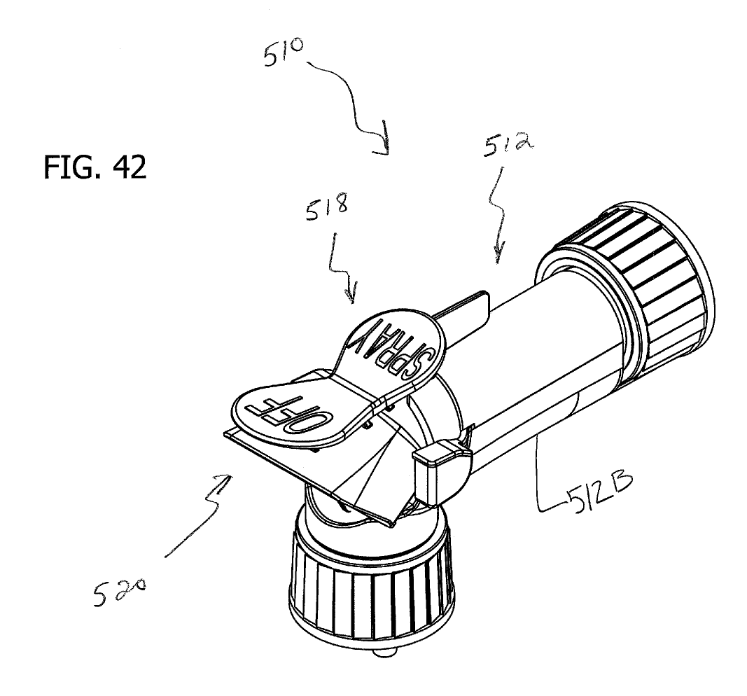

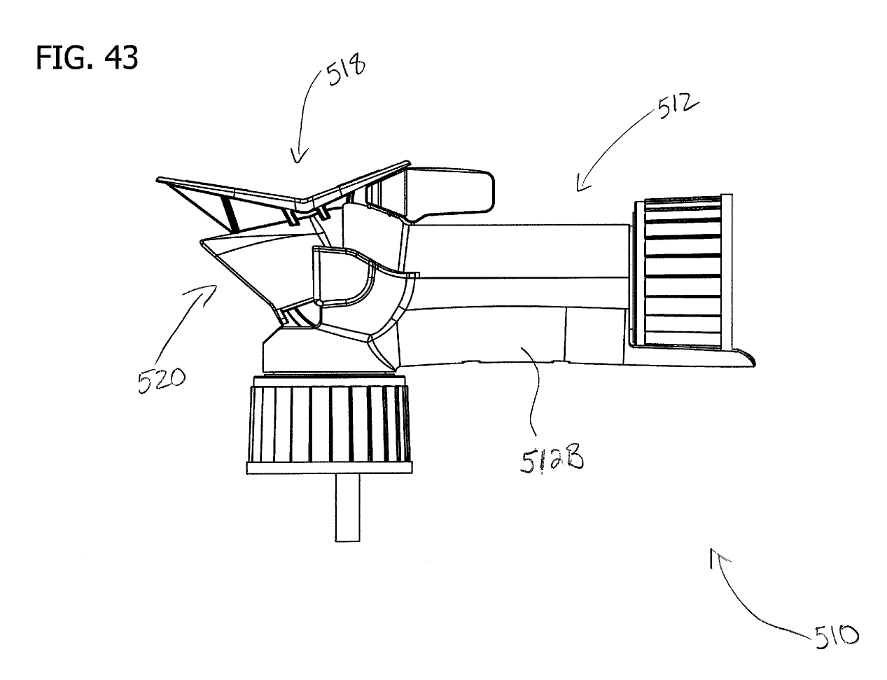

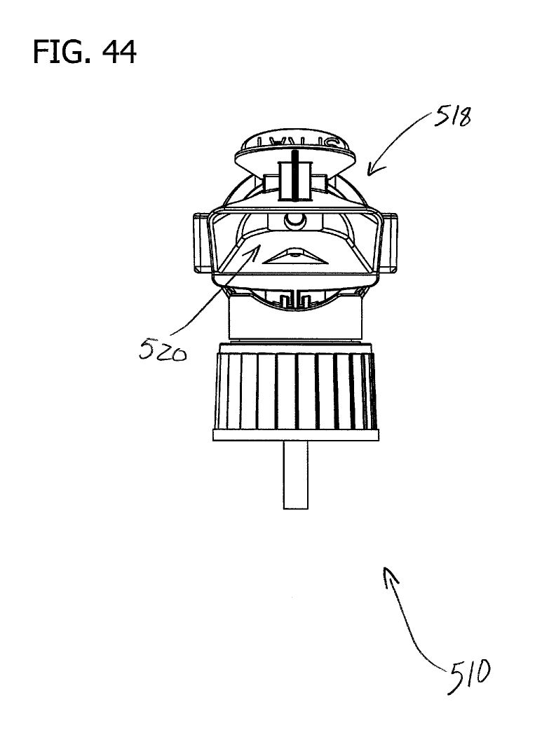

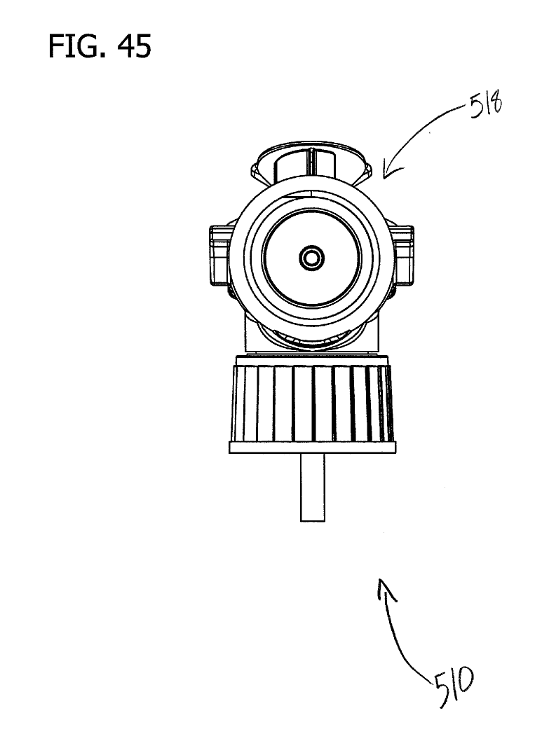

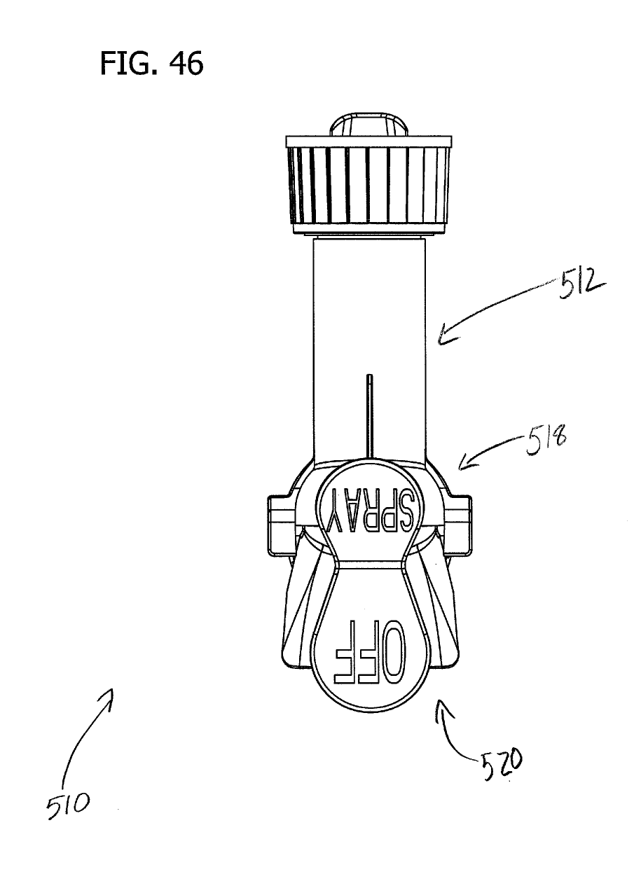

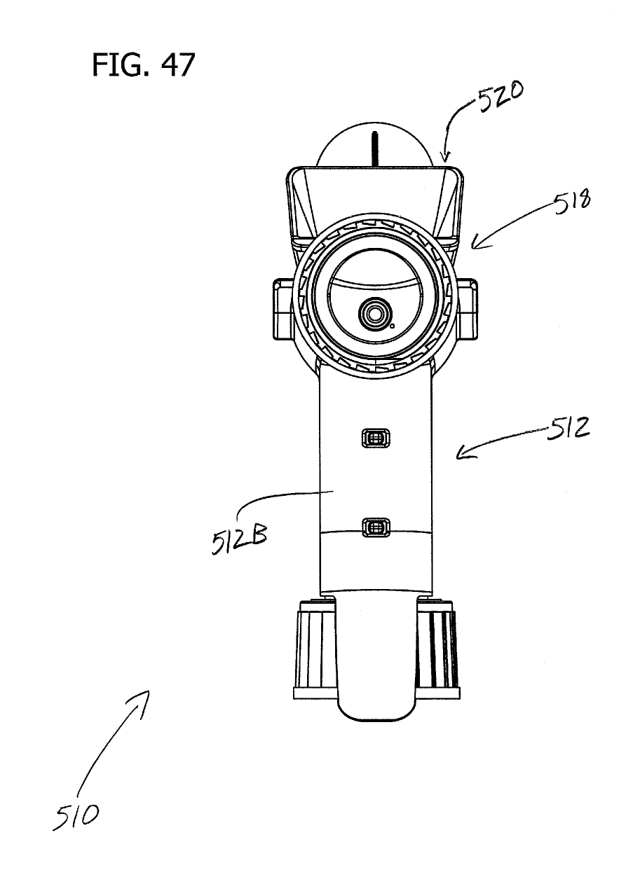

A dispenser 510 of a sixth embodiment of the present invention is illustrated in FIGS. 42-47. The dispenser 510 is similar to the dispenser 10 of the first embodiment, and corresponding parts are indicated by corresponding reference numbers, plus 500. For example, the dispenser 510 includes a body 512, a valve 518, and a nozzle 520. In this embodiment, the valve does not include notch-and-guide stops such as the stops 145, 147 of the first embodiment. In addition, the dispenser 510 does not include a leak guard such as the leak guards 90C, 92C of the first embodiment. Moreover, the dispenser 510 includes a gripping surface 512B substantially the same as the gripping surface 212B provided in the third embodiment. The dispenser 510 is otherwise identical to and functions the same as the dispenser 10 of the first embodiment.

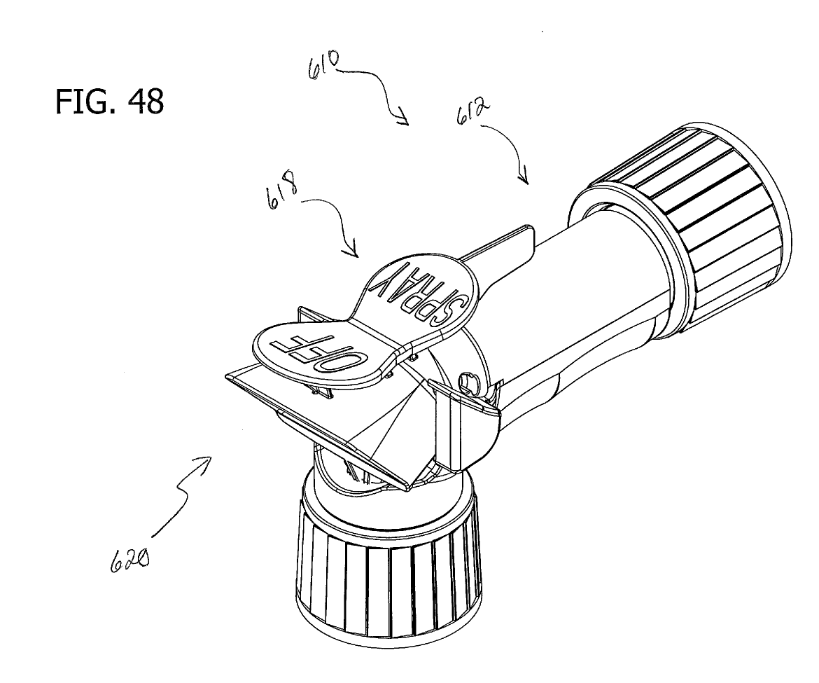

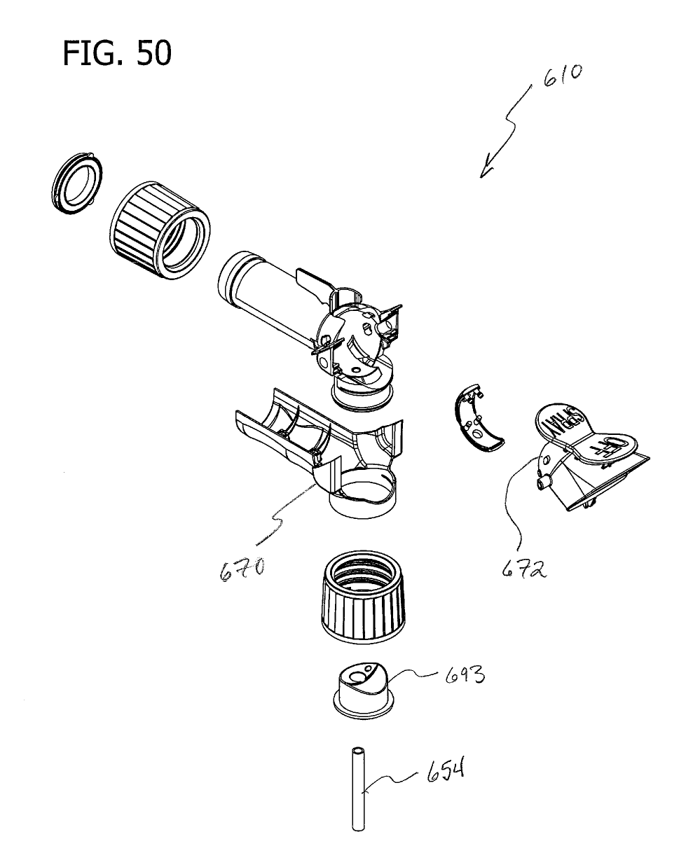

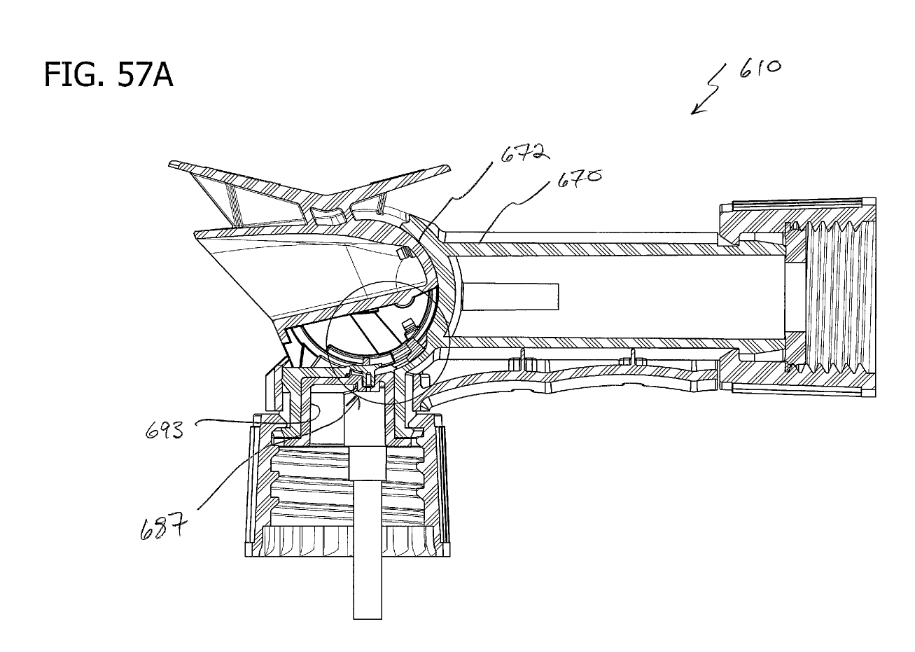

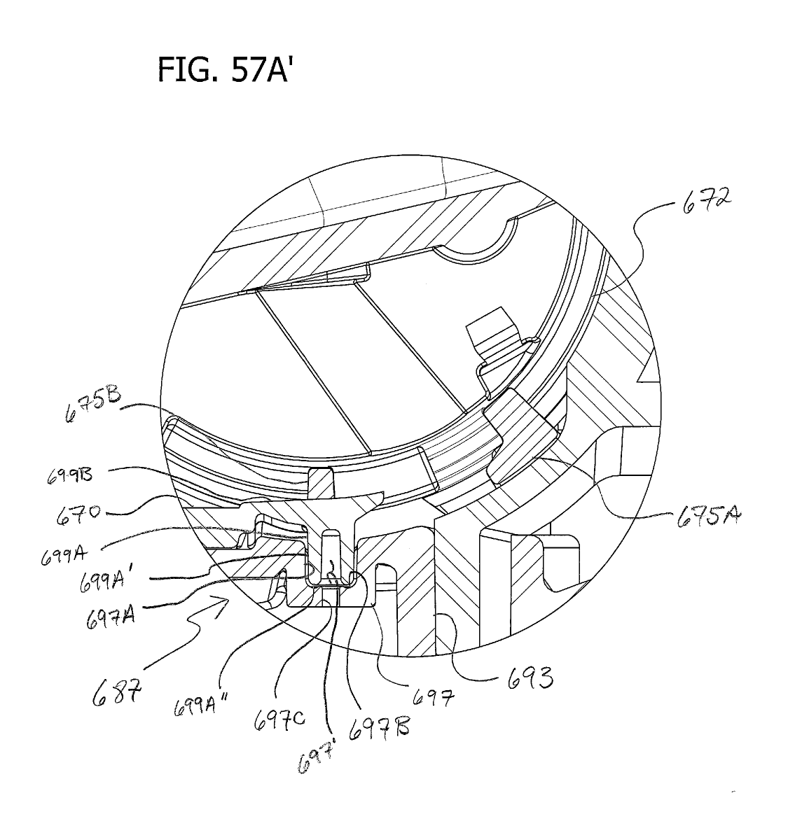

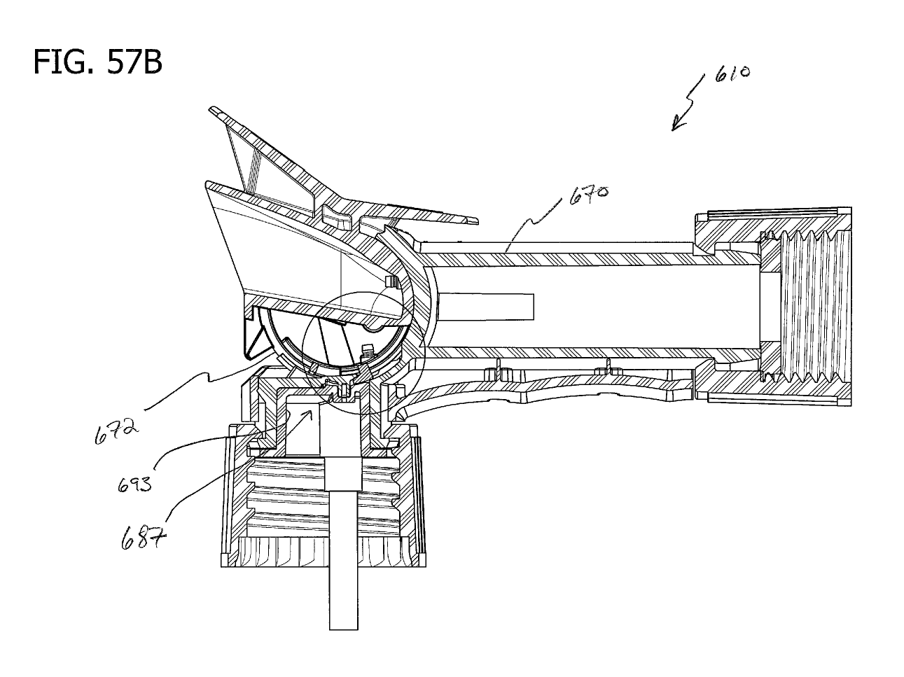

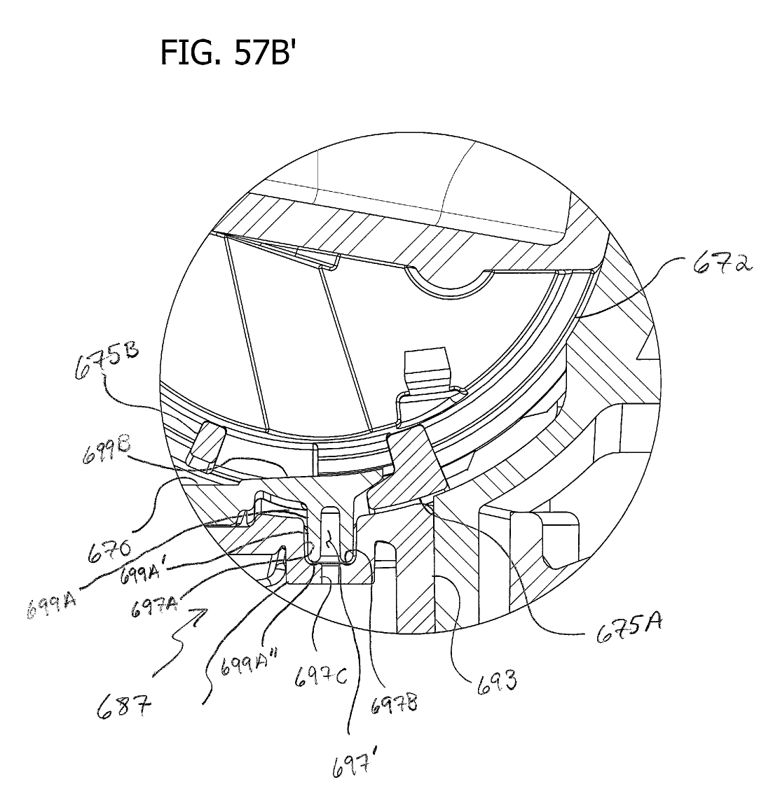

A dispenser 610 of a seventh embodiment of the present invention is illustrated in FIGS. 48-57. The dispenser 610 is similar to the dispenser 10 of the first embodiment, and corresponding parts are indicated by corresponding reference numbers, plus 600. For example, the dispenser includes a body 612, a valve 618, and a nozzle 620. The valve 610 has closed and open positions such as shown in FIGS. 11A and 11B with respect to the first embodiment. In this embodiment, the dispenser 610 includes a vent valve, generally designated by 687 (FIGS. 57A′ and 57B′), which is actuated by movement of the valve member 672 for permitting or blocking venting of the aspiration reservoir. The vent valve 687 is formed by structure on an aspiration fluid inlet gasket 693 and the valve housing 670. The vent valve 687 is actuated by structure on the valve member 672, which opens the vent valve 687 and seals the vent valve as a result of rotation of the valve member between its open and closed positions (e.g., FIGS. 11A and 11B). The vent valve 687 is different than previous embodiments in that the valve member 672 does not form a part of the vent passageway but instead is used to actuate the vent valve 687 formed by the valve housing 670 and the aspiration fluid inlet gasket 693.

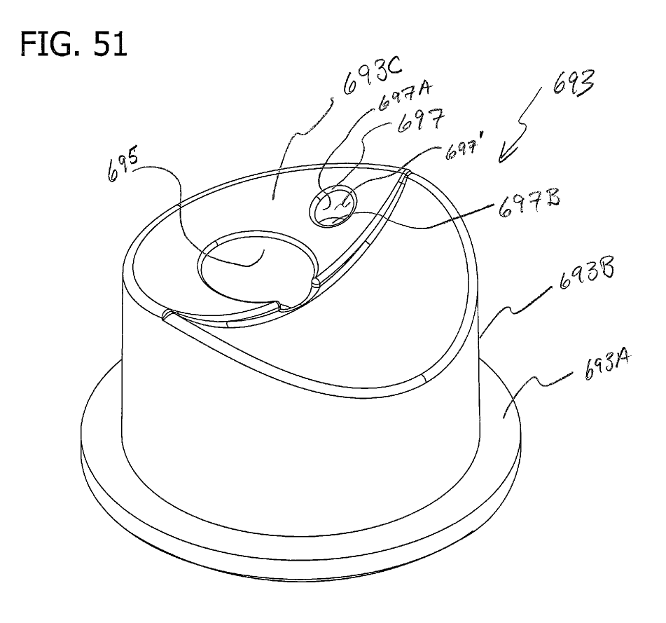

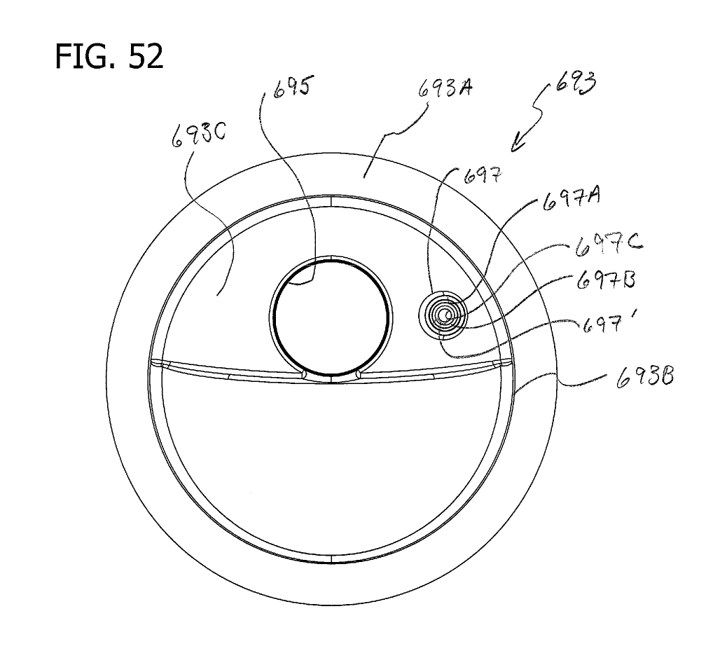

Referring to FIGS. 51 and 52, the aspiration fluid inlet gasket 693 includes a peripheral rim 693A (corresponding to the gasket 42A of FIG. 7), an upstanding cylindrical side wall 693B having a hollow interior, and a top wall 693C which is contoured or curved to generally correspond to the exterior surface of the valve member 672. The gasket 693 includes an opening 695 in the top wall 693C through which the aspiration fluid siphon tube 654 is receivable. In addition, a vent pocket or cavity 697 extends downward into the hollow interior of the gasket 693 from the top wall 693C. The pocket 697 defines a vent passage 697′ bounded by a generally cylindrical side wall 697A and a bottom wall 697B. The vent passage 697′ provides fluid communication between the open atmosphere and an interior of an aspiration fluid reservoir connected to the dispenser 610. The vent passage 697′ has an outlet 697C formed in the bottom wall 697B of the pocket 697 which is positioned for fluid communication with the interior of the aspiration fluid reservoir.

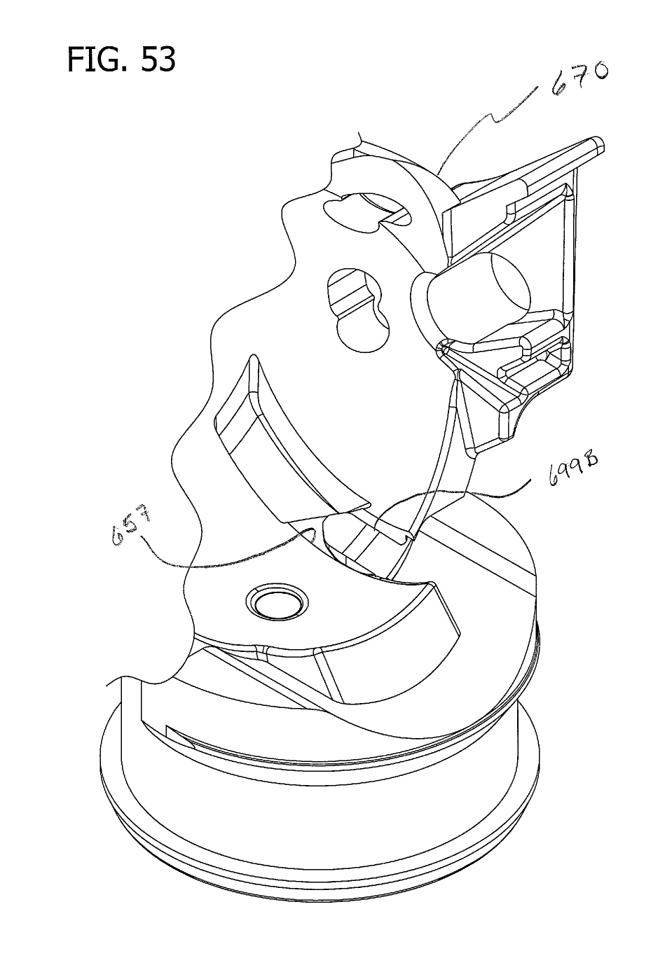

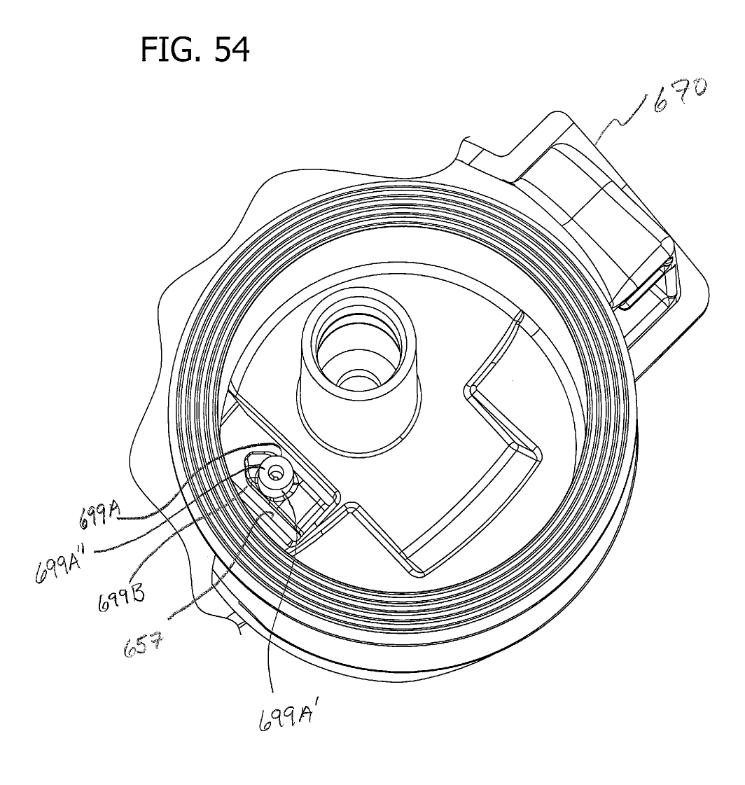

Referring to FIGS. 53 and 54, the valve housing 670 includes a vent duct 657 corresponding to the vent passage 697′ in the gasket 693. Together, the vent duct 657 and vent passage 697′ broadly form a vent passageway through the dispenser 610. In the illustrated embodiment, the vent duct 657 is provided in the form of an opening extending through the valve housing 670 in fluid communication with atmosphere. A vent valve cover 699A is provided on an arm 699B formed on the valve housing 670. The arm 699B extends from a side of the vent duct 657 to a central portion of the vent duct to position the valve cover 699A in register with the vent passage 697′ of the gasket 693. In the illustrated embodiment, the vent cover 699A is provided in the form of a plug having a hollow body including a generally cylindrical side wall 699A′. A distal end 699A″ of the cover 699A is rounded for engaging the bottom wall 697B of the vent passage 697′ in the gasket 693. As described in further detail below, the cover 699A is movable between blocking and venting positions to prevent or permit flow of venting fluid through the vent passageway.

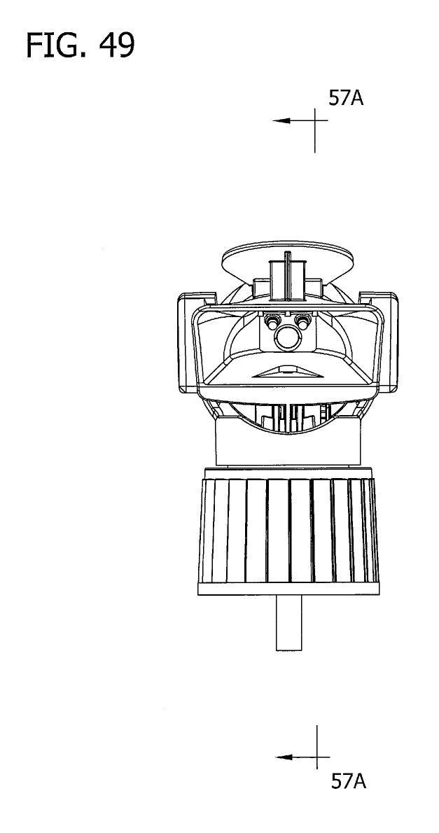

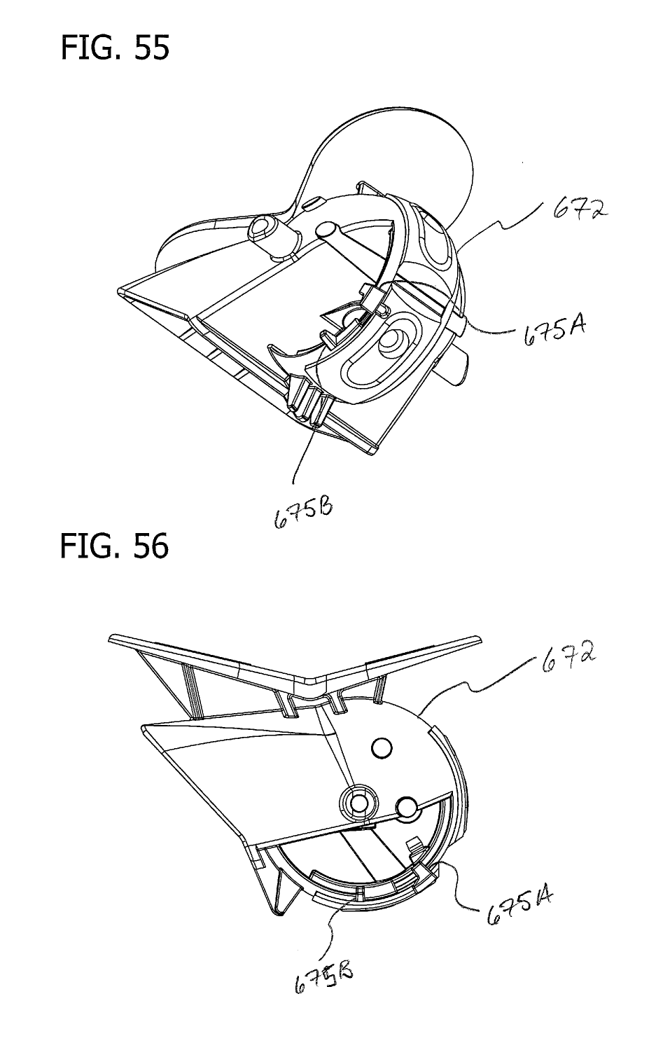

Referring to FIGS. 55 and 56, the valve member 672 includes structure configured for actuating the vent valve cover 699A when the valve member is moved between its open and closed positions. More specifically, the valve member 672 includes an opening actuator 675A and a sealing actuator 675B. In the illustrated embodiment, the opening and sealing actuators 675A, 675B are cams which move the cover 699A by cam engagement with the arm 699B. FIGS. 57A and 57A′ illustrate the valve member 672 in its closed position (e.g., corresponding to the open position of FIG. 11A). In this position, the cover 699A is lodged in the vent passage 697′ in the gasket 693 for blocking flow of vent fluid through the vent passage. The cylindrical side wall 699A′ and rounded bottom 699″ of the cover 699A may engage the respective cylindrical side wall and bottom wall of the vent passage 697′ for sealing the passage. For example, the cylindrical side wall 699A′ of the cover 699A may have a diameter about the same as or slightly greater than the inside diameter of the side wall of the vent passage 697′. It will be understood that the engagement of the cover 699A with the vent passage 697′ is shown schematically in FIGS. 57A and 57A′ in that the cover is not illustrated in actual engagement with walls of the passage 697′ but would be in practical application. In the closed position, the sealing actuator 675B of the valve member 672 engages an inner side of the arm 699B opposite the cover 699A for pressing the cover into sealing engagement with the side wall 697A and bottom wall 697B of the pocket 697. The arm 699B may be biased toward the pocket 697 such that the arm itself moves the cover 699A into the pocket, and the sealing actuator 675B of the valve member 672 enhances the sealing engagement of the cover 699A in the pocket. FIGS. 57B and 57B′ illustrate the valve member 672 in its open position (e.g., corresponding to the open position of FIG. 11B). As shown by comparison of FIGS. 57A′ and 57B′, when the valve member 672 is moved toward from its closed position to its open position, the sealing actuator 675B of the valve member rotates away from the cover 699A, releasing the cam force of the sealing actuator on the arm 699B, and the opening actuator 675A rotates toward the cover. A wedge of the opening actuator 675A engages a distal end of the arm 699B and wedges it upward such that the cover 699A is drawn away from the vent passage outlet 697C in the bottom wall of the pocket 697B. Accordingly, cam engagement of the opening actuator 675A moves the cover 699A at least partially out of the vent passage 697′ of the gasket 693 for permitting flow of vent fluid into the aspiration fluid reservoir from ambient via the vent passageway. The vent duct 657 is in continuous fluid communication with open atmosphere via a space 611 which opens out of the valve housing 670 at a front end of the valve housing below the nozzle 620 (FIG. 49).

As is now apparent, rotation of the valve member 672 to the “on” position opens simultaneously the carrier fluid, aspiration fluid, and vent passageways to permit fluid flow therethrough. Moreover, rotation of the valve member 672 to the “off” position closes simultaneously the carrier fluid, aspiration fluid, and vent passageways to block fluid flow therethrough.

The vent valve may have other configurations without departing from the scope of the present invention. For example, the cover may have other configurations, and the gasket may have other configurations without departing from the scope of the present invention.

It will be understood that the dispenser 610 may be otherwise identical to and function the same as the other dispensers disclosed herein.

It will be understood that although the levers disclosed herein are illustrated as being on the top of the dispensers, in some embodiments the levers may be provided on the bottom or sides of the dispenser without departing from the scope of the present invention.

Having described the invention in detail, it will be apparent that modifications and variations are possible without departing from the scope of the invention defined in the appended claims.

When introducing elements of the present invention or the preferred embodiment(s) thereof, the articles “a”, “an”, “the”, and “said” are intended to mean that there are one or more of the elements. The terms “comprising”, “including”, and “having” are intended to be inclusive and mean that there may be additional elements other than the listed elements.

As various changes could be made in the above constructions and methods without departing from the scope of the invention, it is intended that all matter contained in the above description and shown in the accompanying drawings shall be interpreted as illustrative and not in a limiting sense.

What is claimed is:

1. A hose end dispenser for dispensing a carrier fluid and an aspiration fluid, the dispenser being adapted for operation by a single hand of a user, the hand including a plurality of fingers including a thumb, the dispenser comprising:
a body including a carrier fluid inlet and an aspiration fluid inlet;
a nozzle configured for dispensing the carrier fluid and the aspiration fluid, the nozzle being positioned downstream from carrier fluid inlet and the aspiration fluid inlet;
a valve downstream from the carrier fluid inlet and upstream from the nozzle, the valve including a valve member and a valve housing, the valve member being rotatable in the valve housing about and axis of rotation for moving the valve member between an open position in which the valve member permits flow of carrier fluid through the valve member and a closed position in which the valve member blocks flow of carrier fluid through the valve member;
a rocker lever connected to the valve member, the rocker lever being configured for rocking actuation by the thumb of the hand for moving the valve member between the open and closed positions;
wherein the body includes a grip having a top, a bottom, a rear end, a front end, and a length extending between the front and rear ends, the grip being positioned in front of the carrier fluid inlet and behind the nozzle, the grip including a gripping surface extending along the length of the grip, the gripping surface being sized and shaped for receiving fingers of the hand wrapped on the gripping surface including fingers of the hand positioned one in front of the other between the rear and front ends of the grip, the rocker lever being positioned for actuation by the thumb when the fingers are wrapped on the gripping surface.

2. A hose end dispenser as set forth in claim 1 wherein the rocker lever includes a first actuation member having a first surface positioned for engagement by the thumb to move the valve member to the open position, and a second actuation member including a first surface positioned for engagement by the thumb to move the valve member to the closed position, the first surfaces making a non-orthogonal angle with respect to each other.

3. A hose end dispenser as set forth in claim 2 wherein the first and second actuation members each comprise a second surface opposite the first surface, wherein the second surfaces are facing toward the valve and the first surfaces face away from the valve in all positions of the rocker lever.

4. A hose end dispenser as set forth in claim 2 wherein the first surfaces of the first and second actuation members define a generally “V” shape.

5. A hose end dispenser as set forth in claim 1 wherein the rocker lever is located on a top side of the valve.

6. A hose end sprayer as set forth in claim 3 wherein movement of the rocker lever between the open and closed positions moves each of the first and second actuation members of the rocker lever forward and rearward along the top of the valve.

7. A hose end sprayer as set forth in claim 6 wherein in the closed position of the valve member the first actuation member of the rocker lever is in a forward position with respect to the valve member and in the open position of the valve member the first actuation member of the rocker lever is in a rearward position behind the forward position with respect to the valve member.

8. A hose end sprayer as set forth in claim 2 further including a frangible tab positioned between the first actuation member and the valve housing, the frangible tab preventing rotation of the valve member to the open position, the frangible tab being removable to permit rotation of the valve member to the open position.

9. A hose end dispenser as set forth in claim 1 wherein the body includes a carrier fluid path in fluid communication with and extending between the carrier fluid inlet and the nozzle, the body includes an aspiration fluid flow path in communication and extending between the aspiration fluid inlet and the nozzle, and the carrier and aspiration fluid flow paths each extend through the valve member.

10. A hose end dispenser as set forth in claim 9 wherein the carrier fluid path extends through the grip.

11. A hose end dispenser as set forth in claim 1 wherein the nozzle is connected to and is movable with the valve member when the valve member is moved between the open and closed positions.

12. A hose end dispenser for dispensing a carrier fluid and an aspiration fluid, the dispenser comprising:
a body including a carrier fluid inlet and an aspiration fluid inlet;
a nozzle configured for dispensing the carrier fluid and the aspiration fluid, the nozzle being positioned downstream from carrier fluid inlet and the aspiration fluid inlet;
a valve downstream from the carrier fluid inlet and aspiration fluid inlet and upstream from the nozzle, the valve including a valve member and a valve housing, the valve member being rotatable in the valve housing about the axis of rotation for moving the valve member between an open position in which the valve member permits flow of carrier fluid through the valve member and a closed position in which the valve member blocks flow of carrier fluid through the valve member, the valve including a stop including a protrusion and a track, the track having first and second ends and a length extending between the ends, the track receiving the protrusion and permitting the protrusion to move along a length of the track when the valve member is moved between the open and closed positions, the protrusion being positioned at one of the first and second ends of the track when the valve member is in one of the open and closed positions for preventing rotation of the valve member beyond said one of the open and closed position.

13. A hose end dispenser as set forth in claim 12 wherein the protrusion is provided on the valve member and the track is provided on the valve housing.

14. A hose end dispenser as set forth in claim 14 wherein the track includes a detent between the ends of the track which frictionally engages the protrusion when the valve member is in the open position to maintain the valve member in the open position until the valve member is rotated with sufficient force toward the closed position to overcome the frictional engagement of the protrusion with the detent.

15. A hose end dispenser for dispensing a carrier fluid and an aspiration fluid, the dispenser comprising:
a body including a carrier fluid inlet and an aspiration fluid inlet;
a nozzle configured for dispensing the carrier fluid and the aspiration fluid, the nozzle being positioned downstream from carrier fluid inlet and the aspiration fluid inlet;
a valve downstream from the carrier fluid inlet and aspiration fluid inlet and upstream from the nozzle, the valve including a valve member and a valve housing, the valve member being rotatable in the valve housing about the axis of rotation for moving the valve member between an open position in which the valve member permits flow of carrier fluid through the valve member and a closed position in which the valve member blocks flow of carrier fluid through the valve member; and
a vent valve including a cover and a vent passage, the cover having an open position in which vent fluid is permitted to flow through the vent passage and the cover having a closed position in which vent fluid is blocked from flowing through the vent passage;
wherein the valve member includes structure which engages the vent valve cover and moves the vent valve cover to the open position of the vent valve cover in response to rotation of the valve member toward the open position of the valve member.

16. A hose end sprayer as set forth in claim 15 wherein the valve member includes a sealing member including an engagement surface configured for engaging and sliding on an inner wall of the valve housing, the sealing member including a carrier fluid opening extending through the sealing member, the sealing member including a leak guard extending in a loop circumscribing the carrier fluid opening.

17. A hose end dispenser as set forth in claim 16 wherein the leak guard comprises a raised member protruding outward from the engagement surface of the sealing member, the raised member engaging the inner wall of the valve housing with a tighter fit than the engagement surface of the sealing member.
